(19) United States
(12) Patent Application Publication
(10) Pub. No.: US 2026/0368445 A1
(43) Pub. Date: Nov. 19, 2026

(54) SYSTEM

(71) Applicant: SoftBank Group Corp., Tokyo (JP)

(72) Inventor: Hiroyuki TERAKADO, Tokyo (JP)

(73) Assignee: SoftBank Group Corp., Tokyo (JP)

(21) Appl. No.: 19/561,726

(22) Filed: Mar. 10, 2026

(30) Foreign Application Priority Data
Mar. 19, 2025 (JP) 2025-044965

(51) Int. Cl. G06F 40/40; G06F 40/268; G06F 40/30; G10L 13/08

(52) U.S. Cl. CPC G06F 40/40; G06F 40/268; G06F 40/30; G10L 13/08

(57) ABSTRACT

A system includes a processor that is configured to: collect inquiry data in a centralized manner from a plurality of inquiry contact points within an organization and store the collected inquiry data in an integrated database, analyze the inquiry data by using natural language processing, and generate and input a prompt for instructing a generative AI model to analyze a content of an inquiry included in the inquiry data, and analyze an answer generated by the generative AI model and apply the analyzed answer to a related business process.

### CROSS-REFERENCE TO RELATED APPLICATION

This application is based on and claims priority under 35 USC 119 from Japanese Patent Application No. 2025-044965 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In organizations, inquiries from employees and other internal users are typically handled by a plurality of separate inquiry contact points, such as IT helpdesks, HR desks, general affairs desks, and project-specific desks. As a result, inquiry data is dispersed across multiple systems and departments, making it difficult to centrally manage inquiry histories, to accumulate knowledge, and to reuse past responses. Furthermore, conventional systems generally provide only rule-based or template-based responses and cannot sufficiently understand the context and intent of inquiries expressed in natural language. Therefore, it is difficult to generate appropriate and tailored answers that reflect complex business rules and workflows. In addition, even when the content of an inquiry requires escalation to or consultation with a specific key person, conventional systems do not adequately support automatic identification of such a key person or provision of contact information based on analysis of the inquiry content. Consequently, there is a need for a system that can centrally collect and store inquiry data from multiple inquiry contact points, that can accurately analyze inquiry content by using natural language processing and a generative AI model, that can apply generated answers to related business processes, and that can search and present appropriate key persons and their contact information in accordance with the content of the inquiry.

### SUMMARY

To solve the above-described problems, according to one aspect of the present invention, there is provided a system comprising a processor. The processor is configured to collect inquiry data in a centralized manner from a plurality of inquiry contact points within an organization and to store the collected inquiry data in an integrated database, thereby enabling unified management and accumulation of inquiry histories. The processor is further configured to analyze the inquiry data by using natural language processing, and to generate and input a prompt for instructing a generative AI model to analyze a content of an inquiry included in the inquiry data, so that the generative AI model can understand the intent and context of the inquiry expressed in natural language. Moreover, the processor is configured to analyze an answer generated by the generative AI model and to apply the analyzed answer to a related business process, for example by mapping the answer to internal procedures, systems, or workflows.

In one embodiment, the processor is configured to analyze an inquiry by using natural language processing, to search related information based on an analysis result of the inquiry, and to generate a prompt for instructing the generative AI model to perform context analysis in order to generate an appropriate answer by using the generative AI model. In another embodiment, the processor is configured to search an appropriate key person based on a content of an inquiry, and to generate a prompt for instructing the generative AI model to analyze the content of the inquiry and to search a related person database in order to provide contact information of the key person. By these means, the system realizes centralized collection and utilization of inquiry data, high-precision analysis and answer generation by cooperation between natural language processing and a generative AI model, and automatic identification of key persons and provision of their contact information corresponding to the inquiry content.

The term “inquiry data” refers to data representing one or more inquiries submitted by users within an organization, including at least a text content of each inquiry and optionally metadata such as a source contact point, user identification information, timestamps, and status information.

The term “inquiry contact point” refers to a physical or virtual interface, such as a helpdesk, portal, chat window, email address, or ticketing system, through which users submit inquiries to an organization.

The term “integrated database” refers to a database or a logically unified data store in which inquiry data collected from a plurality of inquiry contact points is centrally stored and managed so that the data can be accessed and processed in a consolidated manner.

The term “natural language processing” refers to a set of computational techniques for analyzing, interpreting, and processing human language text, including but not limited to tokenization, morphological analysis, syntactic analysis, semantic analysis, intent detection, and entity recognition.

The term “generative AI model” refers to a machine learning model, such as a large language model or other generative neural network, that is configured to generate text or other output content based on input data, prompts, or contextual information.

The term “prompt” refers to data generated by the processor and provided as an input to the generative AI model, the data including instructions, contextual information, and constraints that cause the generative AI model to perform a specific analysis or generation task with respect to inquiry data.

The term “answer” refers to response content generated by the generative AI model based on an inquiry, the response content including at least natural language text that addresses the content of the inquiry and optionally references to related information or procedures.

The term “business process” refers to a series of tasks, workflows, or operations performed within an organization to achieve a business objective, including but not limited to approval flows, support workflows, onboarding procedures, and system operation processes.

The term “context analysis” refers to processing performed by the generative AI model or in cooperation with natural language processing to interpret the meaning, intent, and situational background of an inquiry beyond its literal text, taking into account surrounding information and related data.

The term “key person” refers to an individual within or associated with an organization who has a particular role, responsibility, expertise, or authority relevant to the content of an inquiry, and who is an appropriate contact for resolution or escalation of the inquiry.

The term “person database” refers to a database or data store that maintains information about persons in or associated with an organization, including at least their names, roles, departments, projects, skills, and contact information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

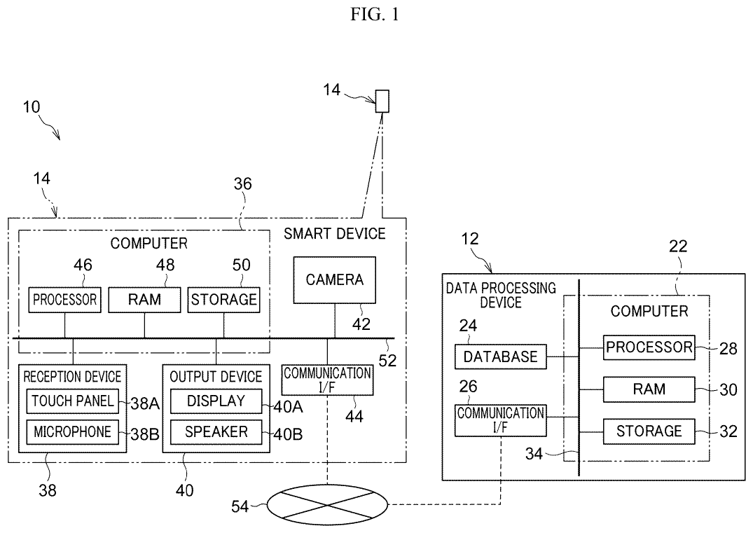

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

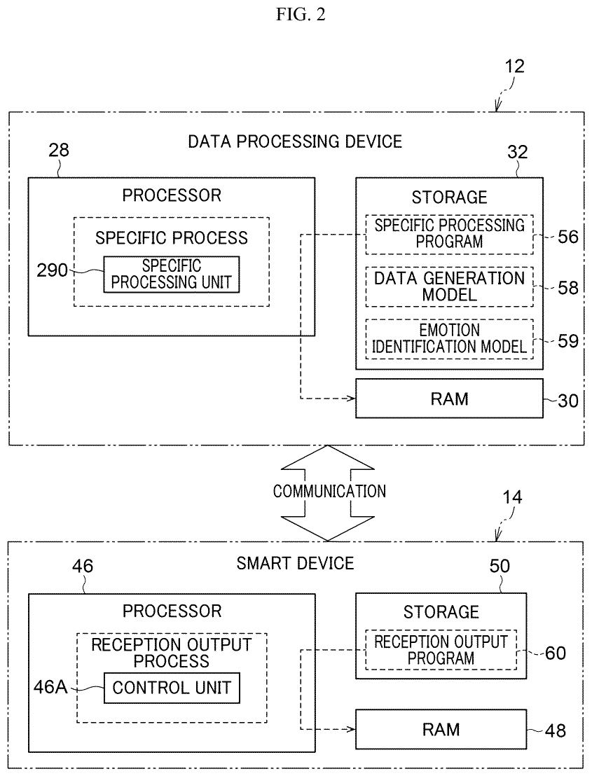

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional inquiry management systems in organizations typically route user inquiries to fixed rule-based workflows or to static knowledge bases. These systems often rely on predefined templates and manually maintained answer repositories. As a result, they exhibit several technical limitations. First, the systems lack a unified processing pipeline that can normalize heterogeneous natural language inquiries coming from multiple channels, such as electronic mail, web forms, and messaging interfaces, into a consistent internal representation managed by a single processor and storage subsystem. This causes redundant storage, inconsistent metadata, and increased latency due to fragmented processing components.

Second, conventional systems do not tightly integrate natural language preprocessing, structured data retrieval from internal business systems, and dynamic prompt construction for a generative AI model within a single coordinated control flow. Typically, any use of machine learning or artificial intelligence is added as an external component that receives raw text and returns an answer without awareness of internal business context such as organization structure, project assignments, or deadlines. This leads to technically suboptimal use of compute and network resources, because repeated and unnecessary calls to an external model are made without leveraging intermediate analysis results, historical interaction patterns, or existing structured data.

Third, existing systems generally treat generative AI models as opaque answer generators and do not maintain explicit, machine-readable associations between (i) preprocessed inquiry records, (ii) the exact prompt sentence submitted to the generative AI model, and (iii) the returned natural language answer. Without such associations, the system cannot algorithmically refine prompt construction rules or model control parameters based on accumulated history information. This prevents technical improvements such as automatic tuning of model configuration for different categories and importance levels of inquiries, leading to degraded answer quality, unnecessary token usage, and inconsistent response times.

Fourth, in the specific context of identifying responsible persons or important persons within an organization, conventional solutions often rely on static routing tables or simple keyword-based mappings. These approaches do not combine (a) structured search over a person management database that includes organization structure information and job information with (b) context-aware generation of a prompt sentence that injects candidate person information into a generative AI model. As a consequence, important-person search is technically limited, often inaccurate, and computationally inefficient, because it either underutilizes available structured data or over-depends on the generative AI model without appropriate constraints.

Accordingly, there is a need for an improved computer-implemented system that technically enhances how a processor: (1) centrally receives and stores natural language inquiry records; (2) performs structured preprocessing including intent classification and importance classification; (3) retrieves business-related information from internal systems; (4) constructs optimized prompt sentences for a generative AI model including model control parameters; (5) post-processes answers and manages confidential information; and (6) maintains and exploits history information to iteratively refine the prompt construction rules and model configuration. Such a system should reduce redundant computation, improve the efficiency and reliability of inquiry handling, and provide technically superior integration between natural language processing components, internal databases, and external generative AI services.

The specific processing by the specific processing unit 290 of the data processing device 12 in Example 1 is realized by the following means.

The present invention provides a server comprising a processor and a storage apparatus, the processor being configured to centrally receive, via a communication interface, inquiry information from a plurality of inquiry reception units within an organization, store the inquiry information together with source identification information as inquiry records in the storage apparatus, apply string normalization processing and morphological analysis processing to natural language text included in the inquiry records to determine an intent classification and an importance classification for each inquiry, acquire business-related information from at least one information processing apparatus or information management apparatus based on the intent classification and the importance classification, construct a prompt sentence including the natural language text, the intent classification, the importance classification, and the business-related information so as to cause a generative AI model to execute context analysis and answer generation processing, transmit the prompt sentence and associated control parameters for the generative AI model via an external interface, receive a natural language answer output from the generative AI model in response to the prompt sentence, perform output format conversion processing and confidential information control processing on contents of the natural language answer to generate display data for an inquiry terminal, and store, as history information, the natural language answer, the corresponding prompt sentence, and the corresponding inquiry record in association with one another and update at least one of a construction rule of the prompt sentence and an acquisition condition of the business-related information based on the history information. This enables a technically improved inquiry processing pipeline in which the server optimizes use of the generative AI model according to categorized intent and importance, reduces redundant external model calls by leveraging structured preprocessing and internal data retrieval, systematically refines prompt sentences and model control parameters based on accumulated history information, and thereby enhances computational efficiency, response accuracy, and reliability of organization-wide inquiry handling.

The term “system” refers to a combination of hardware and software components that cooperate to perform inquiry processing, including at least one processor, at least one storage apparatus, and communication interfaces.

The term “processor” refers to a hardware computing unit, such as a central processing unit or an execution core, configured to execute machine-readable instructions to perform the described inquiry processing operations.

The term “storage unit” refers to a non-transitory computer-readable storage medium, such as a semiconductor memory or a magnetic storage device, configured to store inquiry records, business-related information, prompt sentences, natural language answers, and history information.

The term “communication interface” refers to a hardware and software interface, such as a network interface controller and a communication protocol stack, configured to transmit and receive data between the system and external devices or services.

The term “inquiry information” refers to data representing a request, question, or issue submitted by a user, including at least natural language text and optionally metadata such as time information and user identification information.

The term “inquiry reception unit” refers to a hardware or software component, such as a client application, web form, or messaging interface, configured to receive inquiry information from a user and transmit the inquiry information to the system.

The term “source identification information” refers to data indicating an origin of an inquiry, including at least one of a user identifier, a device identifier, a communication channel identifier, and an organization unit identifier.

The term “inquiry record” refers to a data structure stored in the storage unit that associates inquiry information with corresponding source identification information, timestamps, classifications, and processing status.

The term “natural language text” refers to character sequences expressed in a human language, such as sentences or phrases, contained in the inquiry information and in the natural language answers.

The term “string normalization processing” refers to a series of text-processing operations, such as character encoding unification, case conversion, whitespace normalization, and removal of extraneous symbols, applied to natural language text to obtain a normalized representation.

The term “morphological analysis processing” refers to natural language processing operations, such as tokenization, part-of-speech tagging, and lemmatization, applied to natural language text to extract word units and grammatical information.

The term “intent classification” refers to a classification result that indicates a type or purpose of an inquiry, such as a request for information, a request for responsible-person identification, or a request for deadline information, determined by analysis of natural language text.

The term “importance classification” refers to a classification result that indicates a priority or urgency level of an inquiry, such as low, normal, or high importance, determined based on natural language text and associated metadata.

The term “business-related information” refers to structured or semi-structured data obtained from an internal information processing apparatus or information management apparatus, such as project information, schedule information, organization structure information, or person information, that is relevant to answering an inquiry.

The term “information processing apparatus” refers to a computer system, such as an application server or business system, configured to store and process business data related to organizational activities.

The term “information management apparatus” refers to a data management system, such as a database management system or a data repository, configured to manage storage and retrieval of business data associated with organizational operations.

The term “prompt sentence” refers to a text sequence constructed by the processor that includes at least natural language text from an inquiry, classification results, and business-related information, and that is formatted to instruct a generative AI model to perform context analysis and answer generation.

The term “generative AI model” refers to a machine-learned model, such as a large-scale neural network, configured to generate natural language output by processing a prompt sentence and performing probabilistic prediction of token sequences.

The term “external interface” refers to a communication mechanism, such as an application programming interface accessible via a network, through which the processor transmits prompt sentences and control parameters to, and receives natural language answers from, the generative AI model.

The term “natural language answer” refers to a sequence of natural language text tokens generated by the generative AI model in response to a prompt sentence, intended to address the content of an inquiry.

The term “output format conversion processing” refers to processing performed by the processor to convert a natural language answer into a display-ready or system-specific format, including at least one of markup embedding, structural annotation, and field extraction.

The term “confidential information control processing” refers to processing performed by the processor to detect, mask, remove, or otherwise control confidential or sensitive information contained in a natural language answer before the answer is provided to an inquiry terminal.

The term “display data” refers to formatted data generated by the processor for presentation on an inquiry terminal, including at least a natural language answer and optionally associated metadata, such as responsible person information and links to business systems.

The term “inquiry terminal” refers to an information terminal device, such as a workstation, mobile device, or web client, configured to transmit inquiry information to the system and display display data received from the system to a user.

The term “history information” refers to stored data that associates, for each interaction, an inquiry record, a corresponding prompt sentence, and a corresponding natural language answer, and that is used by the processor to refine processing rules.

The term “construction rule of the prompt sentence” refers to a rule, template, or algorithm used by the processor to determine how to assemble components such as natural language text, classifications, and business-related information into a prompt sentence.

The term “acquisition condition of the business-related information” refers to a rule set or query condition used by the processor to select which business-related information to retrieve from internal systems based on inquiry characteristics.

The term “person management database” refers to a database system that stores person-related information, including at least organization structure information, job information, and contact information for persons associated with an organization.

The term “organization structure information” refers to data that describes relationships between organizational units and positions, such as departments, teams, and reporting lines within an organization.

The term “job information” refers to data that describes roles, responsibilities, job titles, and functional assignments of persons in an organization.

The term “business attribute information” refers to information extracted from natural language text of an inquiry that characterizes a business context, such as a project name, department name, process type, or time period.

The term “candidate person information” refers to one or more records obtained from the person management database that indicate persons who are potentially responsible or relevant to an inquiry, including at least their identifiers and attributes.

The term “important person search” refers to processing in which the processor identifies one or more persons with responsibility or authority relevant to an inquiry based on person management data and business attribute information.

The term “contact information presentation” refers to processing in which contact data, such as electronic mail address, telephone number, or messaging identifier, for an identified person is prepared and included in a natural language answer or display data.

The term “control parameters for the generative AI model” refers to configuration values provided to the generative AI model, including at least one of a model type, an output length control value, and a generation diversity control value, which influence how the generative AI model generates a natural language answer.

The term “model type” refers to an identifier or selection specifying which generative AI model or which version or configuration of a generative AI model is to be used to generate a natural language answer.

The term “output length control value” refers to a parameter specifying a limit or target for the number of tokens, characters, or sentences in the natural language answer to be generated by the generative AI model.

The term “generation diversity control value” refers to a parameter, such as a randomness or temperature parameter, that influences variability and creativity of token selection by the generative AI model during answer generation.

The term “preprocessing result for the inquiry records” refers to data obtained by performing text normalization, morphological analysis, and classification processing on the inquiry records, including at least intent classification results and importance classification results.

The term “category of each inquiry” refers to a classification label or group assigned to an inquiry based on its content, such as a category for human-resources-related inquiries, project-related inquiries, or system-trouble-related inquiries.

In one embodiment, a server implements the claimed system using a general-purpose computing platform. The server includes at least one multi-core central processing unit, a main memory, a non-transitory storage apparatus, and a network interface controller. The server executes an operating system such as a general-purpose server operating system, and application software implemented, for example, using a web application framework such as a server-side framework, a natural language processing library such as a text-processing library, a machine learning library such as a neural-network library, and a database management system such as a relational database system or a document-oriented database system. The server communicates with one or more terminals via a communication network using a protocol such as HTTPS over TCP/IP.

The terminal is a computing device, such as a desktop computer, a notebook computer, a tablet, or a smartphone, executing a web browser or a native application. The terminal sends inquiry information to the server and displays response data received from the server. The user operates an input device such as a keyboard or a touch panel of the terminal to input a natural language inquiry, and the terminal transmits the inquiry to the server.

The server stores inquiry records in a storage apparatus managed by a database management system. Each inquiry record is implemented as a database row or document including fields such as inquiry_id, user_id, channel_id, received_timestamp, raw_text, normalized_text, intent_class, importance_class, business_context_id, and processing_status. The server also stores business-related information, such as project data, schedule data, and person data, in structured tables or collections, and stores history information that links each inquiry record, a corresponding prompt sentence, and a corresponding natural language answer.

The server uses a natural language processing pipeline implemented with a text-processing library and a machine-learning library. The server performs string normalization processing by converting characters to a unified encoding, standardizing full-width and half-width forms, lowercasing alphabetic characters, normalizing whitespace, and removing non-information-bearing symbols. The server then performs morphological analysis processing by tokenizing the normalized_text into word tokens and punctuation tokens, assigning part-of-speech tags, and mapping tokens to lemmas using a statistical or neural tagger.

The server determines an intent classification and an importance classification for each inquiry by executing a discriminative model implemented, for example, as a transformer-based neural network. The server loads a pretrained transformer encoder model having multiple attention layers, each layer including multi-head self-attention sublayers and feed-forward sublayers with non-linear activation functions. The server converts the token sequence of the normalized_text into token indices using a vocabulary, applies an embedding layer to obtain dense vector representations, and feeds the vectors into the transformer layers.

The server computes a contextualized representation of the entire inquiry by taking, for instance, the vector corresponding to a special classification token or by applying a pooling operation over token vectors. The server then applies a classification head formed by one or more fully connected layers and a softmax layer to output a probability distribution over predefined intent labels and importance levels. The server selects the highest-probability label as the intent_class and the importance_class and writes these values into the corresponding inquiry record.

The server acquires business-related information by executing structured queries against internal information processing apparatuses and information management apparatuses. For example, when the intent_class indicates a project-related inquiry, the server issues an SQL query to a project table including fields such as project_id, project_name, department_id, responsible_person_id, and deadline_date. When the intent_class indicates a person-responsibility inquiry, the server queries a person management database including tables for person, position, and organization_unit. Each person record includes a person_id, name, position_id, organization_unit_id, and contact information. Each position record includes position_id, title, and responsibility_scope, and each organization_unit record includes a hierarchical parent-child relationship. The server constructs a query condition using business attribute information extracted from the normalized_text, such as a project name or department name, and obtains one or more candidate records that match the condition.

The server constructs a prompt sentence by applying construction rules stored in configuration data. The server concatenates fixed template strings with dynamic elements including the original natural language inquiry, the intent_class, the importance_class, and selected business-related information. For example, the server may construct a prompt sentence such as:

“You are an internal support assistant for an organization. Based on the following user inquiry and internal project data, answer clearly and concisely in one or two sentences.

Inquiry: ‘Who is responsible for the new project in the sales department?’

Internal data: project name: New Sales Project; responsible person: a person in charge of the project; department: Sales.

Task: Identify the person responsible for the project and provide the person's name and department.”

In another example, the server may construct a prompt sentence such as: “You are an internal support assistant. Using the following user inquiry and internal schedule data, answer clearly with the exact deadline date.

Inquiry: ‘Please tell me the submission deadline for this month's sales report.’

Internal data: report type: monthly sales report; deadline: a specified date; department: Sales.

Task: State the exact deadline date in natural language and mention the department.”

The server further selects control parameters for the generative AI model based on the preprocessing result for the inquiry records and the history information. The server maintains, in the history information, distributions of model performance metrics, such as average answer length, correction rate, and user feedback scores, per intent_class and importance_class. The server analyzes these distributions using statistical routines to select, for each combination of intent_class and importance_class, a model type, an output length control value, and a generation diversity control value that minimize a composite loss function combining answer quality and computational cost. For example, the server may select a model type corresponding to a compact model for low-importance or high-volume categories and a model type corresponding to a larger model for high-importance categories.

The server may set a stricter output length control value for short-notice alerts and a lower diversity control value for factual queries to reduce variance and improve consistency.

The generative AI model is implemented as a transformer-based autoregressive neural network trained on large-scale text corpora. The model consists of an embedding layer, positional encoding, multiple stacked transformer decoder layers, and a final linear layer mapping hidden states to vocabulary logits. Each transformer decoder layer comprises multi-head self-attention mechanisms, layer normalization operations, and position-wise feed-forward networks. During training, the model minimizes a cross-entropy loss between predicted token distributions and ground-truth next tokens using stochastic gradient descent or a variant such as Adam. The model updates weight parameters via backpropagation, computed over mini-batches of token sequences. The training data may be augmented by synthetic paraphrasing or domain-specific fine-tuning data that include internal-style inquiries and answers, thereby improving performance in organizational inquiry contexts.

At inference time, the server sends the prompt sentence and the selected control parameters to the generative AI model via an external interface, such as a RESTful API over HTTPS. The server converts the prompt sentence into a request body, includes the model type identifier, the maximum output token length, and a temperature parameter or similar generation diversity control parameter, and transmits the request. The generative AI model computes token probabilities at each time step using the transformer decoder layers and generates a sequence of tokens according to a decoding strategy, such as greedy decoding or nucleus sampling constrained by the control parameters. The model outputs a natural language answer string to the server.

The server receives the natural language answer and performs output format conversion processing. The server applies text post-processing routines that may include normalization of line breaks, insertion of markup tags for display, and extraction of specific fields, such as a person name or a date, using pattern-matching or named entity recognition. The server also performs confidential information control processing by scanning the answer for sensitive patterns, such as personal identification numbers or unauthorized contact data, and either masking or omitting such information according to predefined policies. These policies are stored in configuration tables and are applied uniformly to all generated answers. The server then composes display data including the processed natural language answer, optional structured annotations such as links to internal systems, and metadata such as the determined intent_class and importance_class, and transmits the display data to the terminal.

The terminal receives the display data and renders it using a user interface toolkit. The terminal displays the natural language answer in a message view, optionally with highlighted responsible persons or deadlines. The user can read the answer, and if additional clarification is needed, the user inputs a follow-up inquiry. The terminal then transmits new inquiry information, and the above-described processing is repeated.

The server records, as history information, the association between each inquiry record, the corresponding prompt sentence, and the corresponding natural language answer. The server also records evaluation indicators, such as whether the user accepted the answer, whether the answer was edited by an operator, or whether the inquiry required escalation. The server periodically analyzes the history information to adjust the construction rules of the prompt sentence. For example, the server may detect that including explicit department names in the prompt sentence improves answer accuracy for responsibility inquiries and may automatically update a template to always inject department fields. The server may also detect that for certain categories, a shorter answer length yields faster comprehension and thus may reduce the output length control value for those categories.

In an important-person search scenario, the server combines structured database search with generative inference in a non-conventional manner. The server first narrows down candidate persons by executing specific queries against the person management database using attributes extracted by morphological analysis and intent classification, thereby reducing the search space and avoiding brute-force consideration of all employees. The server then injects the candidate person information into the prompt sentence as constrained options, causing the generative AI model to perform disambiguation and explanation within a focused candidate set. This hybrid approach reduces the number of tokens processed by the model, lowers communication overhead, and improves precision, because the model reasons over a curated subset of relevant entities rather than over an unbounded implicit space of possible persons.

This architecture results in technical improvements beyond mere automation of human inquiry handling. By performing intent and importance classification before invoking the generative AI model, the server avoids unnecessary calls to large models and selects appropriate model types and control parameters, thereby reducing computational load and improving response time. By maintaining structured associations between inquiry records, prompt sentences, and answers, and by feeding back history information into the prompt construction and parameter selection processes, the server implements a closed-loop optimization of generative model usage that is not feasible in purely manual workflows. This closed-loop optimization yields improved answer accuracy, reduced variance in output length, and lower error rates in responsible-person identification.

Moreover, the server improves data management by enforcing a consistent internal schema for inquiry records and history information. The explicit fields for intent_class, importance_class, and business_context_id enable indexing strategies and caching mechanisms at the database layer. For example, the server can maintain separate indexes per importance_class to prioritize retrieval of high-importance inquiries, or can cache frequently accessed business-related information associated with specific business_context_id values. These strategies reduce disk access latency and improve throughput of the overall inquiry processing pipeline.

Alternative embodiments are possible within the scope of the claims. In one variation, the server deploys multiple generative AI models, such as a smaller model and a larger model, and dynamically routes prompt sentences to one of the models based on the importance_class and a current system load metric. In another variation, the server performs part of the morphological analysis and classification on an edge server located close to the terminals, thereby reducing core server workload and network latency. In yet another variation, the server introduces additional feature extraction modules, such as character-level convolutional networks for noisy text or domain-specific lexicon matchers, and feeds these features into the classification head or the generative AI model as auxiliary inputs.

In all embodiments, the server applies defined data structures for inquiry records, business-related information, and history information, and executes a specific combination of preprocessing, model control, prompt construction, and post-processing operations that cooperatively improve the functioning of the computer system itself. The resulting system achieves faster and more accurate inquiry handling, reduced communication and computation costs when interacting with a generative AI model, and improved consistency and reproducibility of responses through systematic, machine-driven refinement of prompt sentences and model parameters.

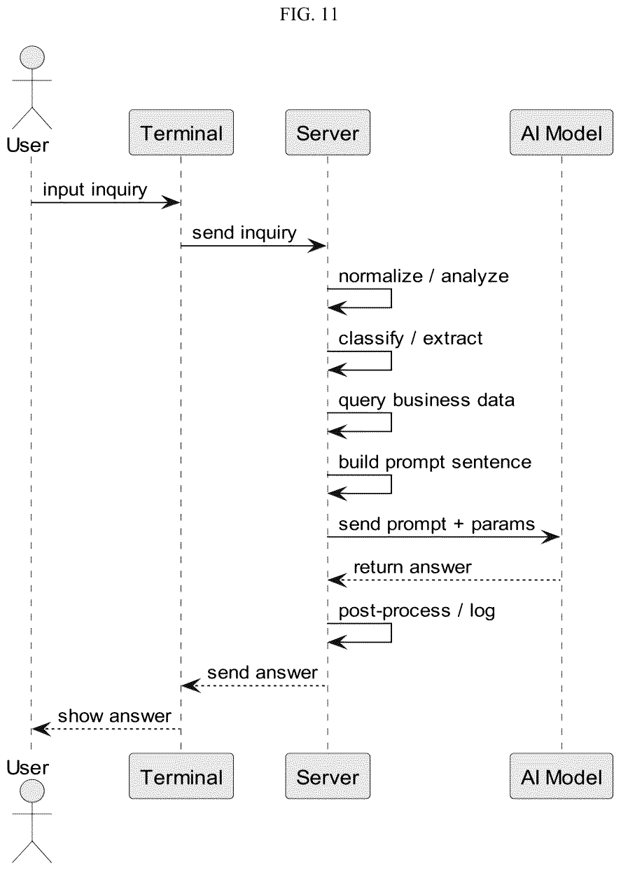

The following describes the processing flow using FIG. 11.

### Step 1

User inputs an inquiry.

User operates a keyboard or touch screen of a terminal to enter a natural language question, for example, “Who is responsible for the new project in the sales department?” or “Please tell me the submission deadline for this month's sales report.” User then activates a send control, such as pressing an on-screen button. The input of this step is raw natural language text typed by the user. The output of this step is the same natural language text and basic metadata (such as time of input) held in the terminal's memory and ready to be transmitted to the server.

### Step 2

Terminal transmits inquiry information to the server.

Terminal executes a client program (for example, a web browser or native application) and constructs a request payload including the user's natural language text, a user identifier, a channel identifier, and a timestamp. Terminal uses an HTTP client library to send this payload via HTTPS over TCP/IP to a predefined API endpoint of the server. The input of this step is the natural language text and metadata obtained in Step 1. The output of this step is an HTTP request containing structured inquiry information that is delivered to the server's communication interface.

### Step 3

Server receives and stores an inquiry record.

Server listens on the API endpoint using a web framework and accepts the HTTP request from the terminal. Server parses the JSON or equivalent structured body to extract fields such as user_id, channel_id, and raw_text. Server generates a new inquiry_id and writes a new record into an inquiry table or collection in a database, storing raw_text, received_timestamp, and initial processing_status. The input of this step is the structured inquiry information from the terminal. The output of this step is a persistent inquiry record stored in the database and a corresponding in-memory data object representing the inquiry for further processing.

### Step 4

Server performs string normalization processing.

Server reads the raw_text field from the in-memory inquiry object and applies normalization routines using a text-processing library. Server converts character encoding to a unified form, normalizes full-width and half-width characters, converts alphabetic characters to lowercase, standardizes whitespace, and removes extraneous control characters. Server produces a normalized_text string and updates both the in-memory object and the inquiry record in the database. The input of this step is raw_text from the inquiry record. The output of this step is normalized_text, which is cleaner and more suitable for subsequent linguistic and machine-learning operations.

### Step 5

Server executes morphological analysis and tokenization.

Server passes normalized_text to a natural language processing module that performs tokenization, part-of-speech tagging, and lemmatization. Server splits the text into tokens, assigns each token a part-of-speech tag, and maps inflected forms to lemmas. Server stores token sequences and associated tags in an intermediate data structure, and optionally writes summarized token information back to the inquiry record. The input of this step is normalized_text. The output of this step is a structured representation consisting of token lists, part-of-speech tags, and lemmas that will be used as input features for classification models and entity extraction routines.

### Step 6

Server determines intent classification and importance classification.

Server feeds the token sequence and normalized_text into a transformer-based classifier implemented in a machine-learning library. Server converts tokens to indices, obtains embeddings, runs them through multiple attention layers, and produces a contextualized vector for the inquiry. Server applies a classification head with softmax layers to compute probability distributions over predefined intent categories and importance levels. Server selects the labels with the highest probabilities and sets these as intent_class and importance_class for the inquiry, updating the inquiry record in the database. The input of this step is the token sequence and normalized_text from Step 5. The output of this step is discrete classification values for intent_class and importance_class, together with associated confidence scores.

### Step 7

Server extracts business attribute information from the inquiry.

Server analyzes the token sequence and part-of-speech tags to identify candidate entities such as project names, department names, report types, and dates using named entity recognition or rule-based patterns. Server constructs business attribute fields, such as project_name_candidate or department_candidate, and stores them in the in-memory inquiry object and optionally in the database. The input of this step is the tokenized and tagged representation from Step 5. The output of this step is a set of business attribute values that characterize the business context of the inquiry and guide subsequent database queries.

### Step 8

Server retrieves business-related information from internal systems.

Server inspects intent_class, importance_class, and business attribute values to determine which internal databases or applications to query. For example, when intent_class indicates “project owner search,” server constructs an SQL query against a project table using project_name_candidate and department_candidate as conditions. When intent_class indicates “deadline inquiry,” server queries a schedule or reporting table using report_type_candidate and a time period. Server executes these queries via database drivers or API calls, receives result sets containing structured records (e.g., responsible_person_id, deadline_date), and loads these results into memory as business-related information. The input of this step is the set of classifications and business attribute values from Steps 6 and 7.

The output of this step is a set of structured business-related information records that will be fused into the prompt sentence.

### Step 9

Server identifies candidate persons for important-person search.

When intent_class indicates a responsibility or important-person inquiry, server accesses a person management database containing tables for person, position, and organization_unit.

Server constructs join queries that combine these tables and filter by business attribute values such as department_candidate, project_name_candidate, or role keywords extracted from normalized_text. Server executes the queries and obtains candidate person information, including names, roles, and contact data. Server stores this candidate person information in an internal data structure associated with the inquiry. The input of this step is the intent_class and business attribute values from earlier steps. The output of this step is a limited, relevant set of candidate person records that reduce the search space and provide structured input for the generative AI model.

### Step 10

Server selects control parameters for the generative AI model.

Server analyzes the combination of intent_class, importance_class, and, optionally, historical performance statistics stored in history information. Server retrieves per-category parameter recommendations, including a model type identifier, an output length control value, and a generation diversity control value. Server may choose a smaller model type and shorter output length for routine, low-importance inquiries, and a larger model type and more detailed output length for high-importance inquiries. Server composes a control parameter set to be sent with the prompt sentence. The input of this step is the classification outputs from Step 6 and historical statistics associated with similar inquiries. The output of this step is a selected configuration of control parameters for the generative AI model.

### Step 11

Server constructs a prompt sentence for the generative AI model.

Server applies stored construction rules and templates to assemble a prompt sentence string.

Server includes the user's original inquiry, the intent_class, the importance_class, and key business-related information such as project or deadline data, and, when relevant, candidate person information. For example, server constructs text such as:

“You are an internal support assistant for an organization. Based on the following user inquiry and internal project data, answer clearly and concisely in one or two sentences.

Inquiry: ‘Who is responsible for the new project in the sales department?’

Internal data: project name: New Sales Project; candidate responsible persons: [list of names and departments].

Task: Identify the most appropriate responsible person and provide the person's name and department.”

Server stores this prompt sentence in association with the inquiry_id in memory and optionally logs it for audit. The input of this step is the original inquiry text, classifications, and business-related information from Steps 6-9. The output of this step is a completed prompt sentence ready for submission to the generative AI model.

### Step 12

Server sends the prompt sentence and control parameters to the generative AI model.

Server builds an API request including the prompt sentence and the selected control parameters from Step 10. Server specifies the model type identifier, maximum token count, and diversity parameter in the request and sends the request over HTTPS to a generative AI service endpoint. The input of this step is the prompt sentence string and control parameter set from Steps 10 and 11. The output of this step is a transmitted API call that initiates generative inference on remote AI infrastructure.

### Step 13

Server receives and validates a natural language answer from the generative AI model.

Server waits for a response from the AI service, receives an HTTP response containing a generated text string, and parses the response body. Server checks for error codes, verifies that an answer string is present, and optionally checks length or structural constraints. Server may detect anomalies, such as empty output or unsupported characters, and handle them via fallback logic. The input of this step is the HTTP response from the generative AI service.

The output of this step is a raw natural language answer string available in server memory.

### Step 14

Server applies output format conversion processing.

Server processes the raw natural language answer to fit display requirements. Server normalizes line breaks, inserts markup for headings or bullet points if templates require such structure, and extracts structured subfields using simple patterns or named entity recognition.

For example, server may detect and isolate a person name or a date for separate display fields. The input of this step is the raw answer text from Step 13. The output of this step is a formatted answer text and optional structured elements suitable for storage and display.

### Step 15

Server performs confidential information control processing.

Server scans the formatted answer for sensitive entities using pattern matching and classification rules. Server compares detected entities with allowed disclosure lists and masks or removes disallowed items, such as private identifiers or restricted contact information.

Server may, for example, replace a personal phone number with a generic helpdesk address if the policy demands. The input of this step is the formatted answer text from Step 14. The output of this step is a sanitized answer text that complies with confidentiality policies and is safe to provide to the terminal.

### Step 16

Server generates display data and returns it to the terminal.

Server composes a response object containing the sanitized answer text, optional structured data (such as a responsible person's name and department, or a deadline date), and metadata such as intent_class and importance_class. Server serializes this object into a response payload and sends it via HTTPS back to the terminal. The input of this step is the sanitized answer text and related metadata from Steps 14 and 15. The output of this step is an HTTP response that delivers display data to the terminal.

### Step 17

Terminal renders the answer to the user.

Terminal receives the HTTP response from the server and parses the payload. Terminal extracts the answer text and any structured fields and updates its user interface to display the answer, for example in a chat-style view or a dedicated answer panel. Terminal may highlight key data such as names or dates and present action buttons (e.g., “Send email to this person”).

The input of this step is the display data from Step 16. The output of this step is a visual presentation of the answer on the terminal's display, enabling the user to view and act on the information.

### Step 18

Server records history information for optimization.

Server, after sending the response, writes a history entry linking the inquiry_id, the constructed prompt sentence, the control parameter set, and the natural language answer.

Server may also log performance metrics such as processing time and model token usage.

Later, if user feedback or corrections are received, server associates those with the same history entry. The input of this step is the inquiry record, the prompt sentence from Step 11, the control parameters from Step 10, and the answer from Step 13 (or Step 15). The output of this step is an updated history store containing detailed interaction traces that the server uses to refine prompt construction and parameter selection in future processing.

### Step 19

Server updates prompt construction rules and model control strategies.

Server periodically analyzes accumulated history information to detect patterns, such as which prompt formulations yield fewer corrections for a particular intent_class or which control parameter combinations minimize response time without degrading answer quality. Server applies statistical analysis or optimization algorithms to adjust template text, selection

thresholds, and parameter mappings. Server then writes updated rules and parameters into configuration storage used in Steps 10 and 11. The input of this step is the aggregated history information from Step 18. The output of this step is a new set of construction rules and parameter-selection policies that improve subsequent runs of the generative AI model and overall system performance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional inquiry processing systems in organizations typically rely on separate channels such as telephones, electronic mail systems, web forms, and human-operated help desks, each implemented by independent software components. In such systems, voice inquiries are often transcribed manually or processed separately from text-based inquiries, and the resulting data is not stored in a unified, machine-readable format. As a result, the underlying computer system cannot effectively correlate historical inquiries, cannot consistently reuse prior interactions to improve later processing, and cannot efficiently orchestrate external resources such as natural language processing engines and generative AI models. This fragmented architecture leads to redundant processing, inconsistent responses, and inefficient use of computational resources.

Further, in existing systems that employ natural language processing or generative AI models, the models are frequently driven by simple, unstructured prompts derived directly from user text. The computer system does not systematically construct prompt sentences that incorporate relevant structured business data, inquiry metadata, and historical context retrieved from internal databases. Consequently, the generative AI model operates on incomplete or uncontextualized inputs, which degrades answer quality and requires additional manual verification. This increases the computational burden on downstream components, such as separate rule engines or human operators, and prevents the system from achieving reliable, end-to-end automation.

Moreover, conventional architectures do not provide an integrated mechanism for automatically validating and correcting generated answers against authoritative internal data sources. Generative AI models may produce output that is fluent but inconsistent with current records in business management systems or person-related databases. Without automated verification and correction, the computer system either returns potentially inaccurate information to users or depends on human review, increasing latency and workload.

In addition, many existing systems treat “important person search” or responsible-person identification as a separate function that is not tightly integrated with the generative AI pipeline. The computer system may perform directory lookups or schedule retrievals, but it does not automatically embed the retrieved responsible-person data into a structured prompt sentence for the generative AI model, nor does it systematically store the combined inquiry and answer data for reuse. This separation limits the system's ability to generate context-rich, user-friendly responses and to learn from past interactions at the system level.

Accordingly, there is a need for a computer system that improves the underlying computer technology by: (i) unifying voice and text inquiries into a single, integrated inquiry data flow; (ii) programmatically constructing prompt sentences that combine inquiry content, structured business-related data, and historical inquiry records; (iii) orchestrating a generative AI model as a controlled computational component within this architecture; and (iv) automatically verifying and correcting generated answer data against internal authoritative sources, including person-related data repositories. Such a system would improve the efficiency, reliability, and accuracy of computer-based inquiry processing, reduce redundant processing, and enhance the overall performance of the computing infrastructure that supports organizational inquiries.

The specific processing by the specific processing unit 290 of the data processing device 12 in Application Example 1 is realized by the following means.

The present invention provides a server comprising a processor, a storage device, and a communication interface, the processor being configured to collect, via the communication interface, voice data and character data as unified inquiry data from a plurality of inquiry terminal devices within an organization and to store the unified inquiry data as inquiry records in the storage device, to cooperate with the inquiry terminal devices such that the inquiry terminal devices convert voice data into character data by using a speech recognition processing function and transmit the character data together with user identification information and work status information as structured inquiry data, to analyze the structured inquiry data by using a natural language processing technique in order to determine an inquiry type and a required business process, to acquire, based on the inquiry type and the required business process, business-related data from internal information processing resources including at least one of a business management system, a business recording system, and a person-related storage device, to generate a prompt sentence that combines the structured inquiry data, the business-related data, and optionally one or more past inquiry records retrieved from the storage device, and to instruct a generative AI model to receive the prompt sentence as input and to perform context analysis and answer generation, to obtain answer character data generated by the generative AI model, to verify the answer character data against the business-related data acquired from the internal information processing resources, to correct the answer character data so as to resolve inconsistencies with the business-related data, and to transmit corrected answer character data to the inquiry terminal devices for conversion into voice data by a speech synthesis processing function and for presentation to users. This enables the computer system to improve technical performance by unifying heterogeneous inquiry channels at the data level, by programmatically constructing context-rich prompt sentences that integrate structured internal data and historical records, by orchestrating the generative AI model as a controlled computational service within the server architecture, and by automatically validating and correcting generated answers against authoritative internal resources, thereby reducing processing redundancy, decreasing response latency, and increasing the reliability and accuracy of computer-implemented inquiry handling.

The term “processor” refers to a hardware computation unit, or a combination of hardware computation units, configured to execute instructions stored in a memory to perform operations such as data acquisition, analysis, prompt generation, invocation of a generative AI model, and generation of answer data.

The term “storage device” refers to a non-transitory computer-readable medium, such as a semiconductor memory, magnetic storage, or optical storage, that stores inquiry data, business-related data, person-related data, prompt sentences, answer character data, and inquiry records.

The term “communication interface” refers to a hardware and software component that enables data exchange between the server and external devices or systems over a communication network, including wired or wireless interfaces and associated communication protocols.

The term “inquiry terminal device” refers to an information processing apparatus operated by a user, such as a mobile device, a personal computer, or a dedicated terminal, that acquires user input, performs at least part of speech processing and display processing, and communicates inquiry data and answer data with the server.

The term “voice data” refers to digital information representing an acoustic signal generated by a user's speech, including encoded or raw audio samples suitable for processing by a speech recognition function or a speech synthesis function.

The term “character data” refers to digital information representing text, including alphanumeric characters, symbols, and encoded natural-language sentences derived from speech recognition or direct text input.

The term “inquiry data” refers to data that represents an inquiry from a user, and may include at least one of voice data, character data, user identification information, work status information, and contextual metadata related to the inquiry.

The term “integrated storage device” refers to a storage device or a logical aggregation of storage resources that stores inquiry data and answer data from multiple inquiry channels in a unified, centrally managed data structure.

The term “user identification information” refers to data that identifies a user or a user account, including but not limited to a user ID, an employee number, a login identifier, or a device-associated identifier.

The term “work status information” refers to data that indicates an operational context associated with an inquiry, including at least one of a work shift, a facility identifier, an equipment identifier, a production line identifier, or a task status.

The term “natural language processing technique” refers to a software-based procedure executed by the processor to analyze, understand, or classify natural-language text, including tokenization, part-of-speech tagging, entity recognition, text classification, and other linguistic processing.

The term “inquiry type” refers to a classification label assigned to inquiry data by the processor, indicating a category such as maintenance, safety, production plan, general information request, or responsible-person search.

The term “required business process” refers to a processing operation or workflow, determined based on the inquiry type, that indicates which business-related data should be retrieved and how the generative AI model should be invoked to generate an answer.

The term “internal information processing device” refers to a computing resource within an organization, including servers or systems that provide access to business-related data, such as management systems, recording systems, or directory services.

The term “business-related data” refers to data obtained from an internal information processing resource that is relevant to an inquiry, including at least maintenance schedules, production plans, task logs, safety records, and other operational information.

The term “business management device” refers to a computing system that manages business operations, such as an enterprise resource planning system, a maintenance management system, or a scheduling system, and provides structured business-related data.

The term “business recording device” refers to a computing system that stores logs or records of business activities, such as event logs, transaction histories, or operation histories, which can be retrieved as business-related data.

The term “person-related storage device” refers to a storage system or directory service that stores information about persons within an organization, including names, roles, departments, responsibilities, and contact details.

The term “person-related data” refers to data obtained from the person-related storage device, including responsible person information, role information, and contact information relevant to an inquiry.

The term “responsible person information” refers to data that identifies a person who is in charge of a particular task, resource, or operation, such as a name, a role, or a position within an organization.

The term “contact information” refers to data that enables communication with a responsible person, such as a telephone extension, an electronic mail address, or another communication identifier.

The term “prompt sentence” refers to a text string or a structured message generated by the processor that combines inquiry data, business-related data, and optionally historical data, and is provided as input to the generative AI model to control context analysis and answer generation.

The term “generative AI model” refers to a software-implemented machine learning model, such as a neural network-based language model, configured to receive a prompt sentence and generate answer character data by predicting sequences of tokens.

The term “answer character data” refers to text generated by the generative AI model in response to a prompt sentence, representing an answer to an inquiry, potentially including structured information and natural-language explanations.

The term “verification” refers to a process by which the processor compares portions of answer character data with business-related data obtained from authoritative internal systems, to detect inconsistencies or errors.

The term “correction” refers to a process by which the processor modifies answer character data, in response to verification results, so that specific facts or values align with business-related data obtained from internal sources.

The term “inquiry record” refers to a data structure stored in the storage device that associates at least one instance of inquiry data with corresponding answer character data and optionally metadata such as timestamps and inquiry type.

The term “historical inquiry record” refers to an inquiry record stored prior to a current inquiry, which can be retrieved and used to enrich a new prompt sentence or to inform subsequent processing.

The term “context analysis” refers to processing performed by the generative AI model or by the processor to interpret inquiry data in relation to associated business-related data, historical data, and metadata, in order to generate an appropriate answer.

The term “structured information” refers to machine-readable data output derived from answer character data, such as key-value pairs or fields representing dates, persons, tasks, or statuses, suitable for further automated processing.

The term “speech recognition processing function” refers to a software component executed by an inquiry terminal device or an external service that receives voice data as input and outputs character data representing recognized text.

The term “speech synthesis processing function” refers to a software component executed by an inquiry terminal device or an external service that receives character data as input and generates voice data representing synthesized speech.

The term “output device” refers to a hardware component of the inquiry terminal device, such as a display, a loudspeaker, or a headset, configured to present answer character data or synthesized speech to a user.

The term “communication network” refers to any wired or wireless infrastructure that enables data transmission between the server, inquiry terminal devices, and internal information processing devices, including local area networks, wide area networks, and the Internet.

In one embodiment, a server constitutes a central inquiry processing node in an organizational network. The server includes at least one processor, a main memory, a non-transitory storage device, and a communication interface coupled via a bus. The storage device stores program modules that, when executed by the processor, cause the server to perform integrated handling of voice-based and text-based inquiries from multiple terminals.

The terminals are implemented, for example, as portable information devices or workstations that include a microphone, a speaker, a display, and a local processor running an operating system such as a general-purpose mobile operating system or desktop operating system.

The terminal executes an inquiry application that interacts with a speech recognition service, a text-to-speech engine, and the server. The terminal uses its microphone and an audio capture API to sample analog speech into digital voice data, which is encoded as linear PCM or compressed audio. The terminal transmits this audio to a speech recognition software component, which may be implemented by a cloud-based speech-to-text service or a locally running recognition engine. The speech recognition software applies an acoustic model and a language model to compute, for each time frame, feature vectors such as Mel-frequency cepstral coefficients and converts the voice data into character data representing recognized text. The terminal stores the recognized text in memory and associates it with user identification information and work status information (for example, plant area, equipment identifier, or shift code).

The terminal transmits the structured inquiry data to the server via a secure communication protocol over a communication network. The structured inquiry data is formatted in a predetermined data structure that includes fields such as inquiry_text, user_id, device_id, timestamp, and context_info. This data structure enables the server to perform efficient indexing and retrieval operations in the storage device. The server receives the structured inquiry data via the communication interface and writes the inquiry data to an integrated storage area that stores inquiry records from multiple channels in a unified schema.

The server uses a natural language processing module executed by the processor to analyze the inquiry_text field. The natural language processing module performs tokenization, sentence segmentation, part-of-speech tagging, and named entity recognition using algorithms that may be implemented by statistical models or neural sequence models. The server then applies a classification model to assign an inquiry type label, such as maintenance, safety, production status, or responsible-person search. In one embodiment, the classification model is implemented as a supervised learning model, for example, a support vector machine or a small feed-forward neural network that takes as input a feature vector composed of term frequency-inverse document frequency values, entity tags, and context features derived from the inquiry_text.

The server accesses internal information processing devices through dedicated connectors.

For a maintenance-related inquiry, the server queries a maintenance management system or another business management device by constructing a structured query that references an equipment identifier and time range derived from context_info. For a responsible-person inquiry, the server accesses a person-related storage device implemented, for example, as a directory service, and retrieves person-related data including responsible person information and contact information based on role, department, equipment, and time constraints. The server then converts the retrieved business-related data and person-related data into normalized internal representations, such as key-value maps, and caches them in memory for subsequent use in prompt construction.

The server constructs a prompt sentence for a generative AI model by composing a text string that combines the user's inquiry, classified inquiry type, and retrieved business-related data.

The server uses a prompt generation module that arranges the text in a predetermined template to ensure consistent conditioning of the generative AI model. For example, the server generates a prompt sentence such as:

“You are a factory maintenance assistant. Answer clearly and briefly. User question: ‘When is the next maintenance?’ Internal data: Next maintenance for Line 1 is scheduled on 2026-02-05 at 09:00.”

For a responsible-person search, the server generates a prompt sentence such as:

“You are an internal helpdesk assistant. The user asked: ‘Who is responsible for the safety inspection of Line 3 today?’ Internal data: Responsible person: Ms. Y, Safety Department, extension 3456. Provide a concise answer.”

For production status, the server generates a prompt sentence such as:

“You are an assistant for production status. The user asked: ‘What is the production target for Line 2 today?’Internal data: Today's target for Line 2 is 500 units. Explain this briefly.”

The server executes a generative AI client module that sends the prompt sentence to a generative AI model. In one embodiment, the generative AI model is implemented as a transformer-based neural network language model hosted on an external inference platform.

The model includes multiple layers of self-attention mechanisms, feed-forward sublayers, and layer normalization. The model receives the prompt sentence tokenized into a sequence of subword tokens represented as integer indices. Each token index is projected into an embedding vector, and the model computes context-aware hidden representations via multi-head attention, where each attention head computes attention weights between query, key, and value vectors derived from the hidden states. The model then applies non-linear transformations with learned weight matrices and generates an output token sequence representing answer character data.

The generative AI model is trained in advance using a large corpus of text by minimizing a cross-entropy loss between predicted tokens and ground-truth tokens, and its parameters (weights and biases) are updated using an optimization algorithm such as stochastic gradient descent with momentum or Adam. During training, the model uses teacher forcing and applies regularization techniques such as dropout and weight decay to improve generalization. In an optional fine-tuning stage, the model is adapted using domain-specific data, including anonymized historical inquiries and answers, to increase accuracy in a particular operational environment.

The server receives the answer character data from the generative AI model and parses it into sentences and, if applicable, structured segments. The server executes a verification module that compares portions of the answer character data with the previously retrieved business-related data and person-related data. For example, when the answer contains a date, an equipment identifier, or a person name, the server extracts these entities using natural language processing and checks them against entries in the authoritative internal systems.

When a discrepancy is detected, the server replaces or corrects the relevant segments of the answer text with verified values. This correction process is implemented by deterministic rules that operate on structured entities, so that the text remains grammatically coherent while ensuring factual consistency.

The server stores the final, corrected answer together with the original inquiry data as an inquiry record in the integrated storage device. The inquiry record includes at least the following data fields: inquiry_id, inquiry_text, inquiry_type, context_info, business-related_data_snapshot, prompt_sentence, raw_model_answer, corrected_answer, timestamp, and user_id. The server indexes these records by multiple keys, including inquiry_type and equipment identifier, to support efficient retrieval of historical records during subsequent prompt construction. In later interactions, the server may retrieve one or more similar historical records and embed a brief summary into a new prompt sentence to provide the generative AI model with extended context. This reuse of structured history improves the consistency of answers and reduces the number of external database accesses needed for repeated inquiries, resulting in reduced latency and lower communication load.

The terminal receives the corrected answer character data from the server and displays the text on its display device. The terminal also uses a text-to-speech engine to convert the answer character data into voice data. The text-to-speech engine segments the text into phonetic units, maps them to acoustic parameters, and synthesizes an audio waveform using a parametric or neural vocoder. The terminal then outputs the audio through its speaker or a connected headset. The user hears the synthesized speech that conveys the answer generated and corrected by the server.

In one alternative embodiment, the terminal performs at least part of the natural language processing and prompt generation locally. The terminal may execute a lightweight classification model to pre-classify the inquiry type and attach an initial type label to the inquiry data before transmitting it to the server. This partitioning reduces the amount of text analysis that the server must perform, distributing computation to the network edge. In another embodiment, the server hosts a local generative AI model instance on specialized hardware such as a graphics processing unit or tensor processing unit. The local model uses the same transformer architecture but is quantized to reduce memory consumption, which decreases inference time and allows the server to respond more quickly to high-volume inquiries.

The server improves computer technology in several ways. First, by unifying voice and text inquiries into a single, structured inquiry data format and storing them in an integrated storage device, the server reduces fragmented data structures and enables efficient indexing and retrieval operations. This unification reduces overhead associated with separate processing pipelines and improves memory locality when accessing inquiry records. Second, by programmatically constructing prompt sentences that incorporate not only the user's question but also structured business-related data and historical inquiry records, the server reduces the number of tokens that the generative AI model must infer from ambiguous context. This focused, data-enriched prompting increases answer accuracy and reduces the average length of model output, thereby decreasing computational load in the generative AI model and shortening response times.

Third, by implementing a verification and correction module that operates on structured entities extracted from answer character data, the server creates a deterministic post-processing layer that constrains the generative AI output to remain consistent with authoritative internal data. This architecture reduces the need for human review, decreases the frequency of incorrect answers, and lowers error rates in downstream processes that rely on the answers. Fourth, by storing full inquiry records and using them to condition future prompt sentences, the server exploits feedback from real usage to refine context and progressively reduce redundant database queries. The reduced number of external queries decreases network traffic and improves overall throughput of the system.

The generative AI model operates according to rules and procedures that differ fundamentally from manual human reasoning. The model applies vector-space transformations and attention mechanisms that weigh contributions of all tokens in the prompt sentence, using learned matrices that encode long-range dependencies in the data. The server uses this property to construct prompt sentences where key structured data—such as machine identifiers, time stamps, and person roles—is placed in positions that bias the attention distribution toward those tokens. The resulting technical effect is an increase in correct alignment between natural language output and critical factual fields. Because the server manipulates internal data structures and token sequences to control the generative AI behavior, the improvements manifest at the level of computing performance and data integrity, not merely at the level of business workflow.

In one variant embodiment, the server uses a hybrid model that combines a rules-based engine with the generative AI model. The rules-based engine handles deterministic mappings, such as direct retrieval of exact maintenance dates or direct mapping of equipment codes, while the generative AI model handles explanation, summarization, and natural-language phrasing. The server decides, based on inquiry type and confidence scores from internal classifiers, which parts of the answer to generate via deterministic rules and which parts to generate via the generative AI model. This hybrid approach further reduces computational cost, since the generative AI model is not invoked for trivial lookups, and concentrates model usage on tasks that genuinely benefit from contextual language generation.

The user interacts with the system by operating the terminal in a natural manner, such as issuing voice inquiries on a factory floor. The terminal, the server, and the internal information processing devices collectively implement a closed loop of data acquisition, analysis, generative modeling, verification, and output rendering. Because this loop is implemented by specific data structures, neural model architectures, and verification algorithms at the computer level, the system provides a concrete technological improvement over conventional fragmented architectures that lack unified data flow, structured prompt construction, and automated answer validation.

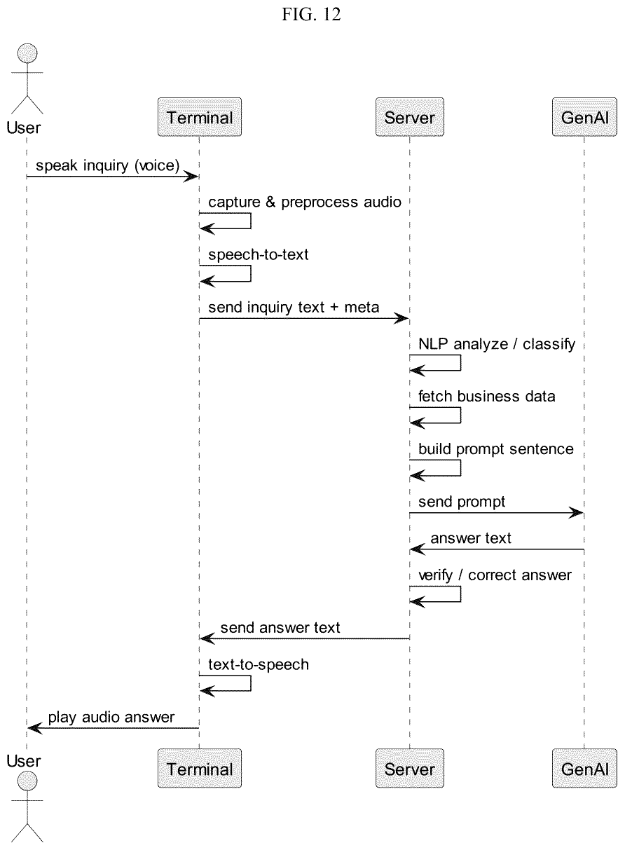

The following describes the processing flow using FIG. 12.

### Step 1

The user activates an inquiry application on the terminal and initiates a new inquiry session.

The user speaks a question, such as “When is the next maintenance?”, into the microphone of the terminal.

The input is analog voice produced by the user; the output is digitized audio samples stored in the terminal's memory.

The terminal uses an audio capture API to sample the analog signal at a predetermined sampling rate (for example, 16 kHz) and quantizes it into digital samples (for example, 16-bit PCM), buffering the samples in an audio buffer for further processing.

### Step 2

The terminal prepares the recorded audio for speech recognition.

The terminal applies optional preprocessing, such as noise reduction and voice activity detection, to the buffered audio samples.

The input is the raw audio buffer; the output is a cleaned and, if needed, segmented audio sequence suitable for recognition.

The terminal computes short-time frames of the signal, estimates background noise levels, suppresses stationary noise components, and trims leading and trailing silence regions, thereby reducing the amount of data transmitted and improving recognition accuracy.

### Step 3

The terminal sends the preprocessed audio to a speech recognition function.

The terminal encapsulates the audio sequence into a request message, adds metadata such as language code and sampling format, and transmits the request via a communication interface to a speech recognition service or local engine.

The input is the cleaned audio sequence and metadata; the output is a recognition request delivered to the recognition function.

The terminal uses a secure protocol (for example, HTTPS) and includes an authentication token in the request headers to authorize access to the recognition function.

### Step 4

The terminal receives recognized text as character data from the speech recognition function.

The recognition function returns a textual hypothesis representing the spoken utterance, and the terminal parses the response and extracts the main recognized string, such as “When is the next maintenance?”.

The input is a recognition response message; the output is a Unicode text string representing the user's question.

The terminal stores this string in memory, assigns it to a field named inquiry_text, and associates it with a timestamp and a temporary inquiry identifier.

### Step 5

The terminal assembles structured inquiry data and sends it to the server.

The terminal combines the inquiry_text, user identification information, device identification information, and work status information (for example, facility ID, equipment ID, and shift) into a structured data object.

The input is the recognized text and terminal-local context; the output is a structured inquiry data packet transmitted to the server.

The terminal serializes this data into a predefined structure, attaches a digital signature or session token for security, and sends it via the communication network to an inquiry endpoint on the server.

### Step 6

The server receives the structured inquiry data and stores an initial inquiry record.

The server parses the incoming data packet, validates required fields, and writes an entry into an integrated storage device, assigning a persistent inquiry_id.

The input is the structured inquiry data from the terminal; the output is a stored inquiry record with status set to “received” or “processing”.

The server executes a database insertion operation that records at least inquiry_id, inquiry_text, user_id, device_id, timestamp, and context_info in a unified table or document collection.

### Step 7

The server analyzes the inquiry text using a natural language processing module.

The server tokenizes the inquiry_text, performs sentence segmentation, part-of-speech tagging, and entity recognition to extract entities such as dates, equipment names, and action verbs.

The input is the inquiry_text string; the output is a set of linguistic annotations and extracted entities.

The server computes feature vectors from the tokens (for example, term frequency-inverse document frequency values, word embeddings) and uses these features to feed a classifier that predicts an inquiry type label, such as “maintenance schedule” or “responsible person search”.

### Step 8

The server determines an inquiry type and a required business process based on the analysis results.

The server evaluates the classifier output and, if necessary, applies rule-based adjustments (for example, if the text contains “who” and an equipment identifier, the server forces the type to “responsible person search”).

The input is the set of features, entities, and preliminary type scores; the output is a final inquiry type and a selection of one or more business processes to execute.

The server updates the corresponding inquiry record with the determined inquiry type and logs this classification for future model evaluation.

### Step 9

The server retrieves business-related data from internal information processing resources.

For a maintenance-type inquiry, the server constructs a query to a maintenance management system using the equipment identifier and time range inferred from the inquiry_text or context_info; for a responsible-person inquiry, the server constructs a search query for a person-related storage device based on role, department, equipment, and date.

The input is the inquiry type, extracted entities, and context_info; the output is one or more business-related data objects, such as a maintenance schedule entry or a responsible-person record.

The server executes database queries or API calls, receives structured results (for example, records containing dates, names, and contact details), and normalizes the results into internal key-value maps or structured objects.

### Step 10

The server prepares a data context bundle for prompt construction.

The server aggregates the business-related data, the inquiry_text, the inquiry type, and possibly selected historical inquiry records retrieved from the storage device.

The input is the current inquiry record and the retrieved business-related data; the output is a context bundle that includes all information needed to generate a prompt sentence.

The server filters out outdated or irrelevant records, selects concise summaries of past answers, and compresses the data into short textual fragments to control prompt length.

### Step 11

The server constructs a prompt sentence for a generative AI model.

The server combines the user's question and the context bundle into a textual template that defines the role of the model and the desired answer style.

The input is the context bundle; the output is a complete prompt sentence string.

For example, the server generates a prompt sentence such as: “You are a factory maintenance assistant. Answer clearly and briefly. User question: ‘When is the next maintenance?’ Internal data: Next maintenance for Line 1 is scheduled on 2026-02-05 at 09:00.”

The server encodes the prompt sentence into the format expected by the generative AI model interface and records the prompt in the inquiry record.

### Step 12

The server sends the prompt sentence to the generative AI model and requests answer generation.

The server transmits the prompt sentence as model input, specifying parameters such as maximum token length, temperature, and response format constraints.

The input is the prompt sentence and the generation parameters; the output is a generation request dispatched to the generative AI model.

The server uses a client library or HTTP-based API to send the request and starts a timer to measure inference latency for performance monitoring.

### Step 13

The server receives answer character data generated by the generative AI model.

The generative AI model processes the prompt sentence by tokenizing it, computing contextual embeddings through multiple layers of self-attention and feed-forward transformations, and predicting a sequence of output tokens that form the answer.

The input received by the server is a response message containing tokenized or textual answer content; the output is a decoded text string representing the answer character data.

The server converts the token sequence into plain text if necessary and stores both the raw model answer and any associated metadata (such as log probabilities or finish reasons) in the inquiry record.

### Step 14

The server verifies the generated answer against authoritative business-related data.

The server performs entity extraction on the answer character data to identify dates, equipment identifiers, person names, and contact information, then compares these entities with the previously retrieved business-related data.

The input is the answer character data and the business-related data; the output is a verification result that marks each entity as consistent or inconsistent.

The server runs deterministic comparison rules, for example checking whether the date in the answer matches the maintenance schedule or whether the responsible person matches the directory record, and accumulates any discrepancies in a verification report.

### Step 15

The server corrects inconsistent portions of the answer character data.

The server modifies the textual answer by replacing incorrect entities with authoritative values from the business-related data while preserving grammatical structure as much as possible.

The input is the raw model answer and the verification report; the output is corrected answer character data that is internally consistent with the organization's data sources.

The server uses template-based replacement or constrained text-edit operations focused on specific spans of text corresponding to incorrect entities and then updates the inquiry record to store both the raw and corrected answers.

### Step 16

The server updates the inquiry record with final data and prepares a response packet for the terminal.

The server sets the inquiry status to “answered”, associates the corrected answer, the prompt sentence, and the verification results with the inquiry record, and optionally derives structured summary fields.

The input is the corrected answer character data and the existing inquiry record; the output is an updated record and a response packet containing answer_text and, if applicable, structured attributes such as schedule_date or responsible_person.

The server serializes this response packet into a predetermined format, attaches identifiers such as inquiry_id, and sends it to the corresponding terminal via the communication interface.

### Step 17

The terminal receives the response packet and presents the answer text.

The terminal parses the incoming packet, extracts the answer_text, and displays it in a user interface element, such as a text box or notification area.

The input is the response packet from the server; the output is rendered text on the terminal display and a local copy of the answer stored in the terminal's memory.

The terminal may also map structured attributes (for example, date and contact number) to dedicated UI fields for easier recognition by the user.

### Step 18

The terminal converts the answer text into speech and outputs audio.

The terminal invokes a text-to-speech engine, providing the answer_text, language code, and voice settings (for example, male/female voice, speaking rate).

The input is the answer_text string; the output is synthesized voice data played through the terminal's speaker or headset.

The terminal segments the text into phonetic units, the text-to-speech engine generates an acoustic waveform using parametric synthesis or a neural vocoder, and the terminal uses its audio output API to stream the waveform to the audio hardware so that the user hears the spoken answer.

### Step 19

The user optionally issues a follow-up inquiry based on the received answer.

The user speaks a new question, such as “Who is in charge of that maintenance?”, using the same terminal.

The input is the new analog speech; the output is a new set of digitized audio samples that start another iteration of the processing flow.

The terminal may attach the previous inquiry_id as part of context_info to allow the server to incorporate prior conversation context into the next prompt sentence.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional inquiry response systems in enterprise environments typically route user inquiries to predefined decision trees, static frequently asked question repositories, or rule-based chatbots. Such systems are limited in their ability to understand unstructured natural language, to leverage heterogeneous knowledge sources in a unified manner, and to generate context-aware and actionable responses. As a result, the systems often require extensive manual configuration, are difficult to scale across multiple inquiry channels, and provide inconsistent response quality across different business domains.

In particular, existing systems generally treat natural language understanding, information retrieval, and response generation as independent components that are loosely coupled. This separation leads to inefficient use of computational resources and knowledge assets, and prevents the system from dynamically adapting to the evolving intent and context of users. In addition, many systems do not exploit the full capabilities of generative artificial intelligence models, because they provide only minimal or unstructured inputs to such models, resulting in hallucinated, incomplete, or operationally unusable answers.

From the perspective of computer technology, there is a need for an improved architecture and processing method in which a processor systematically transforms raw natural language inquiries into structured, machine-interpretable representations, uses those representations to orchestrate retrieval of relevant knowledge, and constructs precisely controlled prompt sentences for a generative AI model. Without such an architecture, it is difficult to achieve predictable behavior of the generative AI model, to obtain responses that can be reliably mapped to business process flows, and to reuse interaction history as computable context in subsequent inference steps.

Furthermore, conventional systems rarely integrate the generated responses back into process-executable formats. Answers are typically output as free-form text, which cannot be directly consumed by downstream business process management functions or automation components. This leads to a technical bottleneck where human operators must interpret and manually translate AI-generated text into concrete workflows, thereby negating potential gains in system-level efficiency and automation.

Accordingly, there is a technical problem of providing a computer-implemented system that (i) unifies collection and storage of inquiry data from multiple channels, (ii) performs advanced natural language processing to extract intent, category, and context, (iii) programmatically composes structured prompt sentences that tightly constrain and guide a generative AI model, (iv) generates answer sentences in natural language under such structured control, and (v) converts those answer sentences into structured data aligned with business process flows. Solving this problem requires an improvement in how a processor coordinates natural language processing, knowledge retrieval, generative AI inference, and structured output transformation to enhance the accuracy, reliability, and utility of AI-generated responses within a computer-centric workflow.

The specific processing by the specific processing unit 290 of the data processing device 12 in Example 2 is realized by the following means.

The present invention provides a server comprising a processor configured to collect inquiry data from a plurality of inquiry channels within an organization and store the inquiry data in an integrated storage; acquire, as the inquiry data, inquiry text in natural language received from an information terminal operated by a user; execute natural language processing including morphological analysis, syntactic analysis, and semantic analysis on the inquiry text to extract keywords, intent, category, and context information; search, based on the extracted keywords, intent, category, and context information, for related information from a knowledge base using a structured query language or similarity search; generate a prompt sentence for input to a generative AI model by combining the related information with the inquiry text and by selecting and filling a template associated with the extracted keywords and category; input the generated prompt sentence to the generative AI model executed by a deep learning framework and cause the generative AI model to perform text generation processing to infer an answer sentence in natural language that reflects dialogue history; analyze the generated answer sentence, format the answer sentence into structured data corresponding to a sequence of steps, a list, or a business process flow, and apply a result of the formatting to a business process management function or a business support function; and generate output data by which the formatted answer sentence is transmitted to the information terminal of the user and presented to the user. This enables an improvement in computer technology by providing a controlled interaction pipeline in which the processor transforms unstructured natural language input into structured prompts, constrains and guides generative AI inference using context-rich prompt sentences, and outputs machine-usable structured responses, thereby enhancing response accuracy, consistency, and integration with downstream automated business processes in a way that conventional rule-based or loosely coupled systems cannot achieve.

The term “system” refers to a combination of hardware and software components that cooperate to perform inquiry collection, processing, and response generation.

The term “processor” refers to one or more hardware processing units, such as a central processing unit or a graphics processing unit, and associated control logic configured to execute instructions for implementing the functions described in the claims.

The term “inquiry channel” refers to any communication interface or medium through which a user submits an inquiry, including but not limited to electronic mail, web forms, chat interfaces, and messaging services.

The term “inquiry data” refers to digital data representing a user's inquiry, including natural language text, metadata, timestamps, and information identifying the inquiry channel and the user.

The term “integrated storage” refers to a logical or physical data storage resource, such as a database or file store, configured to centrally store inquiry data collected from multiple inquiry channels.

The term “information terminal” refers to any user-operated computing device capable of transmitting and receiving digital data, including but not limited to a personal computer, a smartphone, a tablet, or a workstation.

The term “natural language” refers to a human language used for everyday communication, such as English or Japanese, as distinguished from programming languages or formal specification languages.

The term “inquiry text” refers to a sequence of characters or tokens in natural language that represents the content of a user's inquiry.

The term “natural language processing” refers to a group of computational techniques and algorithms for analyzing, understanding, and generating human language, including but not limited to tokenization, part-of-speech tagging, syntactic parsing, and semantic interpretation.

The term “morphological analysis” refers to a natural language processing operation that segments text into morphemes or tokens and determines their lexical attributes, such as base forms and parts of speech.

The term “syntactic analysis” refers to a natural language processing operation that identifies grammatical structures in text, including relationships among words and phrases, such as subject, object, and modifiers.

The term “semantic analysis” refers to a natural language processing operation that determines the meaning of text, including relationships among concepts, and resolves ambiguity to interpret user intent.

The term “keyword” refers to a term, phrase, or token extracted from inquiry text that is determined to be important for identifying the topic or subject matter of the inquiry.

The term “intent” refers to an inferred purpose or objective of a user's inquiry, such as requesting configuration instructions, troubleshooting guidance, or access information.

The term “category” refers to a classification label assigned to an inquiry, representing a predefined type or domain of the inquiry, such as email configuration, network access, or account management.

The term “context information” refers to data representing surrounding circumstances of an inquiry, including but not limited to dialogue history, user attributes, system status, and previously retrieved information.

The term “knowledge base” refers to a structured or semi-structured collection of information, such as documents, manuals, frequently asked questions, and configuration guides, that can be searched to obtain content relevant to an inquiry.

The term “structured query language” refers to a formal language used to define, manipulate, and retrieve data from a relational data storage system.

The term “similarity search” refers to a search operation that retrieves data items from a storage system based on similarity metrics between representations, such as vector embeddings or feature sets, rather than exact keyword matching.

The term “related information” refers to information retrieved from the knowledge base that is determined, based on the extracted keywords, intent, category, and context information, to be relevant to the user's inquiry.

The term “prompt sentence” refers to a structured text string prepared as input to a generative AI model, the text string including at least part of the inquiry text and related information and being designed to guide the model's inference behavior.

The term “template” refers to a predefined text pattern containing variable placeholders, which are filled with inquiry text and related information to construct a prompt sentence in a controlled and repeatable manner.

The term “generative AI model” refers to a machine-learned model configured to generate sequences of tokens or text in natural language in response to input, based on parameters obtained through training on large datasets.

The term “deep learning framework” refers to a software platform that provides data structures, numerical operations, and execution engines for defining, training, and running neural network models, including generative AI models.

The term “text generation processing” refers to an inference operation of a generative AI model in which the model produces one or more tokens or words in sequence to form an answer sentence or other natural language output.

The term “answer sentence” refers to natural language text generated by the generative AI model as a response to an inquiry, including one or more sentences that address the user's request.

The term “dialogue history” refers to accumulated records of previous inquiries and system responses associated with a user session or conversation, used as contextual information for subsequent inferences.

The term “structured data” refers to data organized according to a predefined schema, such as key-value pairs, lists, trees, or graphs, which can be directly processed by software components, including business process engines.

The term “sequence of steps” refers to an ordered list of actions or operations that a user or system is instructed to perform to accomplish a task associated with an inquiry.

The term “list” refers to a set of items organized in a defined order or grouping, such as bullet points or numbered elements, derived from an answer sentence for improved readability and machine processing.

The term “business process flow” refers to a model or representation of a series of tasks, decisions, and transitions executed in a business environment to achieve a defined operational objective.

The term “business process management function” refers to a software-controlled function that designs, executes, monitors, or optimizes business process flows using structured data.

The term “business support function” refers to a software-controlled function that assists in performing business operations, including but not limited to ticket management, workflow orchestration, and operational logging.

The term “output data” refers to digital data generated by the processor for transmission to an information terminal, the digital data including at least the formatted answer sentence and presentation-related attributes.

In one embodiment, a server provides an integrated inquiry response system that operates in conjunction with one or more terminals used by users in an organization. The server includes at least one central processing unit, at least one graphics processing unit, a main memory, a non-volatile storage device, a network interface controller, and an operating system such as a general-purpose server operating system. The server executes application programs implemented, for example, using a machine learning framework such as TensorFlow or PyTorch, and natural language processing libraries such as SpaCy or NLTK.

The server also accesses a storage system implementing a relational or non-relational database that serves as an integrated storage and a knowledge base.

The terminal operates as an information terminal that allows a user to input inquiries and view responses. The terminal includes a processor, a memory, a display, an input device such as a keyboard or touch screen, and a communication module for connecting to the server via a packet-switched network. The terminal executes a web browser or a dedicated client application that presents a graphical user interface. The terminal transmits user-entered text to the server using an application-layer protocol such as HTTP or WebSocket, and receives answer text from the server.

The user operates the terminal to input a natural language inquiry. The user may type or dictate a sentence such as “Please tell me how to configure the internal email system.” The terminal converts the input into a character string encoded in a standard character encoding (for example, UTF-8), attaches metadata such as user identifier, time stamp, and channel identifier, and sends the data as inquiry data to the server. The terminal then waits for response data from the server and, upon receipt, displays the formatted answer on the display as a sequence of steps or bullet points.

The server receives inquiry data from multiple terminals and multiple inquiry channels and stores the inquiry data in an integrated storage. The server stores each inquiry in a data structure that includes at least fields for inquiry identifier, user identifier, channel identifier, inquiry text, time stamp, and processing status. By using a single integrated storage, the server reduces redundant communication and processing that would otherwise occur in fragmented systems with separate storages for each channel, thereby improving data management and access efficiency.

The server uses a natural language processing module, implemented using libraries such as SpaCy or NLTK, to process the inquiry text. The server performs morphological analysis by segmenting the text into tokens and determining parts of speech and lemma forms. The server performs syntactic analysis by constructing parse trees or dependency graphs that represent grammatical relationships among tokens. The server performs semantic analysis by mapping tokens and phrases to semantic roles, identifying entities, and estimating the intent and category associated with the inquiry.

The server represents the result of the natural language processing as an internal data structure, for example a graph or a feature vector. In one embodiment, the server encodes each inquiry into a vector of numerical features that include token-level embeddings (such as word or subword embeddings), syntactic dependency features, and semantic role labels. The server computes these features using a neural network model implemented on the graphics processing unit within the server. By using the graphics processing unit and batch processing of multiple inquiries, the server improves processing throughput and reduces latency compared to pure central processing unit implementations.

The server classifies each inquiry into a category such as “email configuration,” “network access,” or “account management” using a trained classifier model. The classifier model may be implemented as a neural network with multiple layers (for example, an encoder network with attention and a classification head) trained using supervised learning with a cross-entropy loss function. The server uses stochastic gradient descent or an adaptive optimization algorithm during training to update model parameters based on labeled training data that includes historical inquiries and manually assigned categories. Because the classifier uses high-dimensional feature representations generated from morphological, syntactic, and semantic analyses, it can more accurately distinguish among categories than simple keyword-based heuristics, thereby improving precision and recall.

The server searches a knowledge base for related information using the extracted keywords, intent, category, and context information. The server uses a combination of structured query language and vector similarity search. For example, the server may first narrow down candidate documents using a relational query based on category and keywords, and then rank the candidates using a similarity measure such as cosine similarity on embedding vectors.

The server generates embedding vectors for both the inquiry and candidate documents using a transformer-based encoder model, again executed on the graphics processing unit. This combination of query filtering and vector similarity reduces the size of the search space and accelerates retrieval while maintaining recall, thereby improving both computational efficiency and result relevance.

The server selects relevant portions from the retrieved documents, such as sections that contain configuration procedures or troubleshooting steps. The server may split long documents into segments and score each segment against the encoded representation of the inquiry. The server stores the selected segments as context information that will be embedded into a prompt sentence for a generative AI model.

The server constructs a prompt sentence that serves as input to the generative AI model. The server maintains a set of templates associated with different categories and intents. Each template includes fixed phrases and placeholder fields for inquiry text, context information, and instructions to the model. For example, the server may use a template such as:

“Act as an internal IT support assistant. Use the following reference to answer the employee's question. Question: ‘[INQUIRY_TEXT]’. Reference: [REFERENCE_TEXT]. Provide a clear, step-by-step answer.”

The server fills the placeholder [INQUIRY_TEXT] with the user's inquiry text, and the placeholder [REFERENCE_TEXT] with the most relevant document segments retrieved from the knowledge base. The server may also embed context from dialogue history, such as previous questions and answers in the same session, into the reference portion or into additional instruction sentences. By selecting and filling templates based on machine-extracted features rather than static rules, the server systematically controls the input to the generative AI model and thereby reduces variance and hallucinations in the model's output.

The server executes a generative AI model using a deep learning framework such as TensorFlow or PyTorch on the graphics processing unit. In one embodiment, the generative AI model is an autoregressive transformer network with multiple self-attention layers, feed-forward layers, and layer normalization. The model parameters are learned from large-scale text corpora using a language modeling objective, where the model predicts a next token given previous tokens. During training, the server (or an external training environment) applies a training algorithm such as Adam, uses a loss function like cross-entropy between predicted token distributions and ground-truth tokens, and performs backpropagation to update weights. The training may include techniques such as learning rate scheduling, dropout regularization, and data augmentation (for example, paraphrasing and masking) to improve generalization and robustness.

The server, when generating an answer, tokenizes the constructed prompt sentence using a tokenizer such as byte pair encoding, converts tokens into integer indices, and feeds these indices as input to the generative AI model. The server controls decoding behavior using parameters such as temperature, top-k or nucleus sampling thresholds, and maximum length.

These parameters are stored in configuration data structures and may be adjusted dynamically based on category and severity of the inquiry. Because the server manages these decoding parameters and prompt structures programmatically, the server can stabilize the style and level of detail in generated answers, which is a technical improvement over naïve model invocation without such control.

The server obtains a sequence of tokens output by the generative AI model and converts the sequence back to a character string representing an answer sentence. The server then analyzes this answer sentence with a post-processing module that performs natural language processing similar to the analysis of the original inquiry. The server identifies imperative sentences, step markers, and parameter values (for example, server addresses, port numbers, or menu labels). The server converts the answer sentence into structured data forms such as a sequence of steps or a business process flow. For instance, the server may represent a sequence of steps as an ordered list of records, each record containing a step index, an action verb, a target object, and optional parameters.

The server applies the structured answer data to an internal business process management function or business support function. The server may map the steps to workflow definitions stored in a process engine, or to tickets in a case management system. By representing generated answers as structured data instead of free-form text only, the server enables downstream modules to automatically execute or monitor parts of the suggested procedure.

This reduces manual interpretation time and errors, and demonstrates that the system goes beyond mere text generation by integrating generative outputs into machine-readable and executable structures.

In another example, the user may ask, through the terminal, “I cannot receive emails on my company account. How can I fix this?” The server analyzes the inquiry, identifies intent related to troubleshooting incoming email, searches the knowledge base for troubleshooting guides, and constructs a prompt sentence such as:

“You are an internal support agent. Answer the following question from an employee with detailed troubleshooting steps: ‘I cannot receive emails on my company account. How can I fix this?’ Use the provided reference information and avoid technical jargon when possible.

Reference: [troubleshooting guide excerpts].”

The server feeds this prompt sentence to the generative AI model and receives an answer that includes a sequence of checks and configuration verifications. The server then parses the answer to extract device settings, network checks, and authentication checks, and stores them in a structured format that can be used to generate diagnostic workflows or automated scripts.

The server improves computer technology in several ways. First, the server reduces processing latency for complex natural language inquiries by distributing computation between the central processing unit and the graphics processing unit, and by using vectorized operations and batch processing in the deep learning framework. Second, the server improves response accuracy and consistency by enforcing structured prompt sentence construction based on machine-extracted features and templates, which narrows the generative AI model's output space and reduces unintended or irrelevant responses. Third, the server enhances data management by unifying inquiry data and knowledge base content into shared structures and indices, which enables more efficient caching, prefetching, and indexing strategies. Fourth, the server reduces communication overhead by extracting and transmitting only relevant document segments and structured answers, rather than full knowledge base contents or verbose logs, thus lowering network traffic between components.

The server implements a training and adaptation process that further enhances technical performance. The server logs inquiry text, generated prompt sentences, model outputs, and user feedback into a training database. Periodically, the server (or an associated training environment) uses these logs to fine-tune the classifier, the embedding models, and the generative AI model. The server applies training procedures that include mini-batch gradient descent, loss functions that penalize incoherence or contradiction with reference documents, and weight regularization techniques. The server may also perform data augmentation by artificially generating paraphrases of inquiries or by masking portions of context and training the model to reconstruct them. Such training strategies improve robustness against noisy inputs and reduce error rates in response generation.

The server uses rules and control logic that differ from conventional rule-based chatbots. Instead of relying solely on static if-then rules, the server uses hybrid rules that operate on feature representations and confidence scores provided by the classifier and retrieval modules. For example, the server may impose thresholds on similarity scores to decide whether to include certain context segments in the prompt sentence, or may adjust decoding parameters when retrieval scores are low. These rules are applied to numerical metrics and model outputs, not just to surface keywords, and therefore define a non-trivial, machine-centric decision process that cannot be executed manually in real time.

The server can be configured with alternative embodiments. In one embodiment, the generative AI model is a sequence-to-sequence transformer with separate encoder and decoder components, where the encoder processes context and the decoder generates answers. In another embodiment, the server uses a recurrent neural network architecture with attention mechanisms instead of a transformer. In yet another embodiment, the server employs multiple generative models specialized for different categories, and selects an appropriate model based on the classifier's output. The server may also vary the structure of templates, for instance using more directive prompts for critical configuration tasks and more open-ended prompts for exploratory questions.

The terminal may also vary across embodiments. In one variation, the terminal is a mobile device running a native application that caches parts of the knowledge base locally and performs preliminary natural language processing to reduce server load. In another variation, the terminal is a thin client that performs minimal processing and relies entirely on the server for text analysis and rendering instructions.

The user benefits from this architecture because the server can provide responses that are both human-readable and machine-structured, generated through a controlled, technically sophisticated pipeline that optimizes computational resources. The server, by integrating feature-based classification, vector-based retrieval, template-based prompt construction, transformer-based generative modeling, and structured post-processing, implements a specific improvement in computer-based natural language processing and response generation that goes beyond mere automation of human inquiry handling.

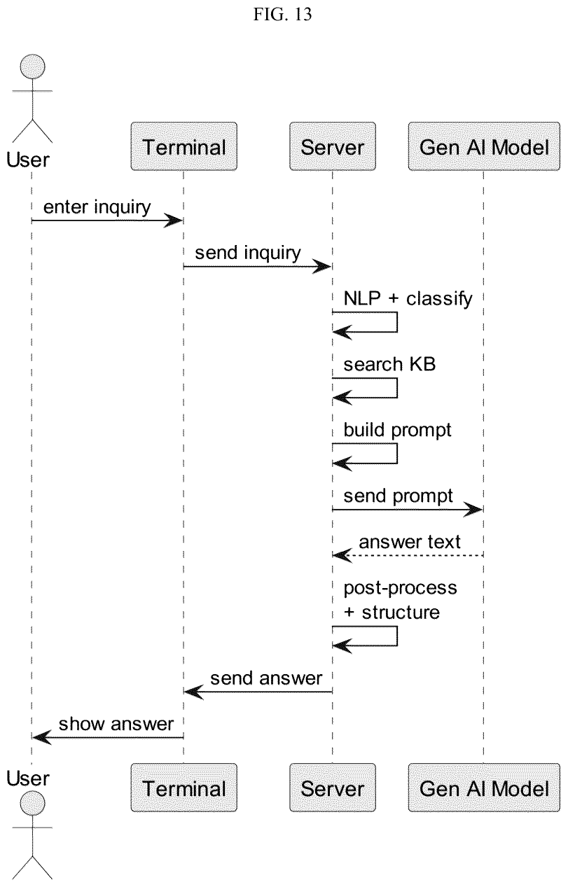

The following describes the processing flow using FIG. 13.

### Step 1

The user operates the terminal to input an inquiry in natural language. The input is a character sequence such as “Please tell me how to configure the internal email system.” The terminal receives this text through a keyboard, microphone with speech-to-text, or touch interface, and converts the raw user interaction into a structured text object with fields including the inquiry text, a user identifier, a channel identifier, and a timestamp. The terminal outputs this structured text object as inquiry data and sends it to the server over a network connection using a protocol such as HTTP or WebSocket.

### Step 2

The server receives the inquiry data from the terminal. The input is the structured text object containing inquiry text and metadata. The server validates the data, normalizes the character encoding (for example, to UTF-8), trims white space, and stores the inquiry data in an integrated storage with a unique inquiry ID. The server outputs a normalized inquiry record that includes the inquiry ID, text, user ID, channel ID, and status flag indicating that analysis is pending.

### Step 3

The server executes natural language processing on the inquiry text. The input is the normalized inquiry text from the inquiry record. The server uses a natural language processing library such as SpaCy or NLTK to perform tokenization, part-of-speech tagging, morphological analysis, and dependency parsing. During this processing, the server converts the character sequence into a token list, assigns grammatical tags, and constructs a dependency graph. The server further applies semantic analysis to identify entities and candidate intents. The server outputs an analyzed inquiry structure that includes tokens, part-of-speech tags, lemma forms, dependency relationships, and preliminary semantic labels.

### Step 4

The server derives feature representations and classifies the inquiry category. The input is the analyzed inquiry structure from Step 3. The server converts tokens and contextual information into numerical feature vectors using an embedding layer (for example, word or subword embeddings) implemented in a deep learning framework such as TensorFlow or PyTorch on a graphics processing unit. The server concatenates or aggregates these embeddings with additional features such as part-of-speech tags and dependency positions.

The server then applies a trained neural network classifier to the feature vectors to infer an intent label and a category label such as “email configuration” or “network access.” The server outputs a classification result object containing the inferred intent, category, and confidence scores.

### Step 5

The server extracts keywords and context information. The input is the analyzed inquiry structure and the classification result object. The server uses rule-based filters and statistical measures (for example, term frequency-inverse document frequency scores or attention weights from the classifier) to select salient terms and phrases. The server may prioritize nouns, noun phrases, and technical terms identified as entities. The server combines these elements with the intent and category labels to form a context descriptor that captures the essential meaning of the inquiry. The server outputs a context descriptor containing a keyword list, an intent label, a category label, and optional dialogue-history references.

### Step 6

The server searches a knowledge base for related information. The input is the context descriptor from Step 5. The server constructs a structured query using the category and keywords for a relational database, and simultaneously computes an embedding vector for the inquiry using an encoder network (for example, a transformer encoder) executed on the graphics processing unit. The server first uses the structured query to retrieve candidate documents, then computes embedding vectors for these candidate documents and evaluates similarity scores such as cosine similarity between the inquiry vector and document vectors.

The server ranks the documents based on similarity and filters out low-scoring items. The server outputs a set of related information objects, each containing a document identifier, relevant text segments, and a similarity score.

### Step 7

The server selects and segments relevant passages. The input is the set of related information objects. The server splits documents into smaller segments (for example, paragraphs or sections), assigns each segment its own similarity score by re-evaluating its embedding against the inquiry embedding, and discards segments below a threshold. The server optionally compresses or summarizes long segments using an extractive summarization algorithm. The output is a context package that includes the top-ranked segments, each with its text, document source, and score, ready to be embedded into a prompt sentence.

### Step 8

The server constructs a prompt sentence for a generative AI model. The input is the context descriptor and the context package. The server selects a prompt template based on the category and intent (for example, a template for configuration guidance or troubleshooting).

The server fills template placeholders with the inquiry text, selected context segments, and explicit instructions to the model. For instance, the server may generate a prompt sentence such as:

“Act as an internal IT support assistant. Use the following reference to answer the employee's question. Question: ‘Please tell me how to configure the internal email system.’

Reference: [email configuration manual excerpt]. Provide a clear, step-by-step answer.”

The server outputs a finalized prompt sentence string along with associated metadata such as template ID and decoding parameters.

### Step 9

The server tokenizes the prompt sentence and prepares model input. The input is the prompt sentence string from Step 8. The server uses a tokenizer associated with the generative AI model, such as a byte pair encoding tokenizer, to convert the string into a sequence of tokens and then into integer token IDs. The server packs these token IDs into a tensor structure and transfers the tensor to the graphics processing unit memory. The server outputs a model input tensor that encodes the prompt sentence in a numerical form suitable for neural network inference.

### Step 10

The server executes the generative AI model to generate an answer. The input is the model input tensor from Step 9. The server loads a generative AI model, such as an autoregressive transformer network, into graphics processing unit memory using a deep learning framework.

The server performs forward passes layer by layer: each layer applies self-attention mechanisms, linear transformations, and non-linear activation functions to propagate and transform the token representations. During decoding, the server iteratively predicts the next token distribution, applies sampling or greedy selection governed by decoding parameters (for example, temperature, top-k, or nucleus thresholds), and appends each selected token to the output sequence until an end-of-sequence token or maximum length is reached. The server outputs a sequence of generated token IDs representing the answer sentence.

### Step 11

The server decodes and post-processes the generated answer text. The input is the sequence of generated token IDs from Step 10. The server converts token IDs back into a character string using the tokenizer's vocabulary. The server then applies normalization and formatting operations such as fixing spacing, correcting punctuation, and unifying line breaks. The server may also apply post-generation rules, for example to remove duplicated phrases or to enforce inclusion of safety disclaimers. The server outputs a clean answer text string in natural language.

### Step 12

The server converts the answer text into structured data. The input is the clean answer text string from Step 11. The server runs a post-processing natural language analysis that detects step markers (for example, “first,” “next,” numbers, or bullet indicators), imperative verbs, and parameter values (such as URLs, server names, and menu paths). The server segments the text into discrete steps and builds a structured representation where each step is stored as a record containing fields for index, action, object, and optional parameters. The server may also map steps to internal process identifiers used by process management systems. The server outputs a structured answer object comprising the step list, any associated metadata, and a human-readable version.

### Step 13

The server integrates the structured answer with process management functions. The input is the structured answer object from Step 12. The server checks for links between step types and existing workflows in a process engine or business support module. For matching steps, the server may generate process instances or tasks, updating relevant databases with new records.

The server may also update logs to record which inquiries triggered which process flows. The server outputs updated process state data and an enriched answer payload that embeds both textual and structured representations.

### Step 14

The server prepares a response message to the terminal. The input is the enriched answer payload from Step 13. The server assembles a response structure that includes the answer text in a user-friendly layout (for example, numbered steps), the structured step list, and contextual metadata such as inquiry ID and processing timestamp. The server serializes this response structure into a message format suitable for network transmission (for example, JSON within an HTTP response body) and attaches the appropriate response headers. The server outputs a response message ready to be transmitted to the terminal.

### Step 15

The terminal receives and renders the response. The input is the response message from the server. The terminal parses the message, extracts the answer text and any structured step list, and updates the user interface. The terminal may display the answer as a numbered list of actions, with optional interactive elements such as buttons linked to specific steps. If structured data is present, the terminal may highlight parameters such as URLs or commands that the user can tap or click. The terminal outputs a rendered display on the screen, allowing the user to view and follow the instructions.

### Step 16

The user reviews the answer and optionally submits follow-up inquiries. The input is the rendered answer on the terminal display. The user reads the steps and performs the operations, such as opening a settings menu or entering configuration values. If additional clarification is required, the user inputs a follow-up question, such as “What should I do if I get an authentication error?” The terminal again converts this follow-up text into inquiry data with dialogue-history references and sends it to the server. The user's follow-up becomes new input for the system, and the server can incorporate the existing dialogue history into the next prompt sentence and subsequent processing.

### Step 17

The server logs interaction data for model improvement. The input is the full set of artifacts generated during handling of an inquiry, including the original inquiry text, analyzed features, selected related information, constructed prompt sentence, generated answer, structured answer object, and user feedback if available. The server writes these artifacts into a training and analytics database, indexing by inquiry ID and category. The server may compute summary statistics, such as error rates or user satisfaction scores, and store them alongside. The server outputs updated training data collections that can later be used to refine classifier models, retrieval models, and generative AI models.

### Applicatclion Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional inquiry handling systems in organizations typically route user inquiries based on static rules, manually defined categories, or simple keyword matching. Such systems suffer from several technical limitations. First, they treat incoming inquiry text as flat strings and do not perform integrated analysis of intent, target event, important expressions, and user emotion in a unified processing pipeline. As a result, the system cannot dynamically adapt its processing flow or resource allocation to the actual semantic content and urgency of the inquiry, which leads to inefficient utilization of computing resources and delayed responses in high-impact scenarios such as security incidents or system failures.

Second, existing systems usually invoke a generative AI model in an ad hoc fashion, for example by passing raw user text to the model, without systematically generating structured prompt sentences that encode routing information, business function type, processing priority, and desired response style. Because the generative AI interface is not tightly integrated with upstream natural language processing and downstream database querying, the system cannot reliably obtain structured outputs suitable for programmatic use. This causes additional post-processing overhead, increases latency, and reduces the determinism and reproducibility of the overall computation.

Third, many systems do not combine the structured output of a generative AI model with internal integrated data storage, such as business data storage areas and person data storage areas, in a coordinated manner. Without a mechanism to merge AI-generated structured data with internal records, the system cannot consistently identify an appropriate person in charge or retrieve precise business information linked to the inquiry. This leads to fragmented workflows where human operators are required to bridge the gap between AI output and internal systems, which degrades scalability and increases the risk of inconsistent handling.

Fourth, conventional architectures rarely treat emotion analysis as a first-class signal for controlling processing priority, escalation behavior, and response generation parameters. In many implementations, emotion or sentiment is either ignored or used only for display. Consequently, the underlying computer system does not exploit emotion as metadata to optimize scheduling of computational tasks, queue management, or the configuration of generative AI calls (for example, choice of response policy or writing style). This results in suboptimal scheduling and failure to prioritize inquiries that technically should be processed earlier due to their risk level or user distress.

In summary, there is a need for a technical solution that: (i) unifies collection of inquiry data from multiple inquiry windows into an integrated data storage; (ii) performs multi-dimensional analysis of intent, target event, important expressions, and emotion state; (iii) dynamically generates prompt sentences for a generative AI model that encode business function type, processing priority, and response policy; (iv) combines AI-generated structured data with internal integrated databases to compute final response text and contact information in an automated manner; and (v) uses emotion and priority signals to update prompt generation logic and improve the performance and reliability of the overall computer system over time.

The specific processing by the specific processing unit 290 of the data processing device 12 in Application Example 2 is realized by the following means.

The present invention provides a server comprising a processor configured to collect inquiry data in an integrated manner from a plurality of inquiry windows within an organization and store the inquiry data in an integrated data storage, to analyze inquiry text acquired from a user terminal by using natural language processing technology and identify, based on an analysis result, an intent of the inquiry, a target event, important expressions, and an emotion state, to determine, in accordance with the identified intent, the target event, the important expressions, and the emotion state, a type of business function for processing the inquiry and a processing priority, to dynamically generate a prompt sentence to be input to a generative information processing apparatus, to input the prompt sentence to the generative information processing apparatus and acquire response information or structured data generated by the generative information processing apparatus, to search, based on the important expressions and attribute information included in the acquired structured data, a business data storage area and a person data storage area in the integrated data storage and extract business information and person-in-charge information related to a content of the inquiry, to generate, based on the response information acquired from the generative information processing apparatus and the extracted business information and person-in-charge information, final response text and contact information and transmit the final response text and the contact information to the user terminal, and to record, based on the emotion state and the processing priority, the inquiry data and response history in an inquiry management storage area, generate statistical information or evaluation information, and update a generation logic of the prompt sentence. This enables the computer system to perform end-to-end, intent-aware and emotion-aware inquiry processing, to dynamically control invocation and configuration of a generative AI model via structured prompt sentences, to automatically integrate AI-generated structured outputs with internal data storage for precise retrieval of business and contact information, and to improve overall response latency, prioritization accuracy, and processing efficiency through feedback of statistical and evaluation information into the prompt generation logic.

The term “inquiry data” refers to data representing one or more user inquiries, including at least textual content of the inquiries and optionally associated metadata such as timestamps, source channels, user identifiers, and processing status information.

The term “inquiry window” refers to a logical or physical interface through which a user submits an inquiry to an organization, such as a help desk interface, a chat interface, a web form, an email gateway, or an application programming interface.

The term “integrated data storage” refers to a storage apparatus or storage area that stores inquiry data collected from a plurality of inquiry windows in a unified format, and that provides a centralized repository accessible by a processor for subsequent analysis, retrieval, and update operations.

The term “user terminal” refers to an information processing device operated by a user to input and receive data, such as a portable terminal, a desktop terminal, or a similar computing device capable of network communication with a server.

The term “inquiry text” refers to a sequence of characters or tokens representing a natural language description of an inquiry, obtained from user input at a user terminal or from another inquiry window.

The term “natural language processing technology” refers to a set of computational techniques executed by a processor to analyze natural language text, including at least one of morphological analysis, tokenization, part-of-speech tagging, syntactic analysis, semantic analysis, named entity recognition, and intent classification.

The term “intent of the inquiry” refers to information indicating a purpose or objective that a user seeks to achieve by the inquiry, such as requesting information, reporting a failure, asking for a status update, or requesting contact with a responsible person.

The term “target event” refers to an event, object, or situation described by an inquiry, such as a particular project, a facility, a system component, or a business process to which the inquiry relates.

The term “important expressions” refers to one or more words, phrases, or entities extracted from inquiry text or structured data that are determined to be relevant for identifying the intent, the target event, or related business data or person-in-charge information.

The term “emotion state” refers to information indicating an affective condition of a user inferred from inquiry text, such as anger, dissatisfaction, anxiety, or satisfaction, and optionally including an intensity value or score for each emotion.

The term “type of business function” refers to a classification of a processing function to be executed in response to an inquiry, such as a product information function, a troubleshooting function, a key person search function, a security incident handling function, or a general information function.

The term “processing priority” refers to a level or rank that controls scheduling or order of processing of inquiry data by a computer system, determined based on at least one of intent, target event, and emotion state.

The term “prompt sentence” refers to a text or token sequence that is generated by a processor and supplied as input to a generative information processing apparatus, the text or token sequence encoding at least part of an inquiry context, including intent, target event, important expressions, processing priority, and response policy.

The term “generative information processing apparatus” refers to an information processing apparatus or model configured to generate response information or structured data in accordance with an input prompt sentence by using machine learning or artificial intelligence techniques, such as a generative AI model.

The term “response information” refers to text, tokens, or other data generated by a generative information processing apparatus as a candidate response to an inquiry represented by a prompt sentence.

The term “structured data” refers to data generated by a generative information processing apparatus or other component and arranged in a predefined structure, such as key-value pairs, records, or fields, including at least one of important expressions, attribute information, target event information, and role information.

The term “business data storage area” refers to a logical region within the integrated data storage that stores data relating to business processes, products, projects, or services, such as records of operations, status information, or configuration information.

The term “person data storage area” refers to a logical region within the integrated data storage that stores data relating to persons involved in an organization, including at least identifiers, roles, responsibilities, and contact information for potential persons in charge.

The term “person-in-charge information” refers to information indicating at least an identity and a role of a person who is determined to be responsible for or relevant to a target event or an inquiry, and may further include contact information.

The term “final response text” refers to text generated by a processor based on response information and internal data, the text being adapted for presentation to a user as a final response to a corresponding inquiry.

The term “contact information” refers to data used to initiate communication with a person, such as telephone number, electronic mail address, communication account identifier, or similar information.

The term “inquiry management storage area” refers to a storage region that stores, for each inquiry, at least inquiry data, processing priority, emotion state, response history, and related management information used to control and evaluate inquiry processing.

The term “response history” refers to information representing one or more responses generated or transmitted for a given inquiry, including at least timestamps, response text identifiers, and processing results.

The term “statistical information” refers to information obtained by a processor through aggregation or analysis of a plurality of records, such as distributions, averages, or counts relating to inquiries, priorities, emotion states, or response performance.

The term “evaluation information” refers to information indicating performance or quality of inquiry processing, such as accuracy indicators, latency measures, user feedback scores, or success or failure flags derived from response history.

The term “generation logic of the prompt sentence” refers to a set of rules, parameters, models, or procedures executed by a processor to determine content, structure, and wording of a prompt sentence from inquiry data, analysis results, and stored statistical or evaluation information.

In one embodiment, a server cooperates with a plurality of user terminals to implement an integrated inquiry processing system. The server includes at least one processor, a main memory, a non-volatile storage device, and a network interface, all coupled via a hardware bus. The server runs an operating system such as a general-purpose server operating system and executes application software written, for example, in a high-level language. The server communicates with user terminals over a packet network using secure transport protocols.

A terminal includes an input device and a display device, such as a touch screen of a portable terminal or a monitor and pointing device of a desktop terminal. The terminal runs a client application implemented, for example, by a cross-platform framework or a browser-based interface using markup language, style sheets, and script language. The terminal acquires inquiry text from a user and transmits the inquiry text, together with metadata such as a terminal identifier and timestamp, to the server via the network interface. The terminal receives response text and contact information from the server and renders the received information on the display device using graphical user interface components.

The server stores inquiry data from multiple inquiry windows in an integrated data storage. The integrated data storage is implemented by a database management system such as a relational database server executing on the server hardware, and includes logical regions such as an inquiry table, a business data storage area, a person data storage area, and an inquiry management storage area. The inquiry table stores records including at least an inquiry identifier, inquiry text, user identifier, source window identifier, and timestamp. The business data storage area stores records representing projects, products, services, systems, or facilities, each record including attributes such as a business identifier, name, category, status, and associated process identifiers. The person data storage area stores records representing potential persons in charge, each record including attributes such as a person identifier, role, responsibility area, and contact information. The inquiry management storage area stores for each inquiry at least a processing priority, an emotion state, and a response history.

The server uses a natural language processing module to analyze inquiry text. The natural language processing module runs on the processor and uses a statistical or neural language model to perform tokenization, part-of-speech tagging, syntactic parsing, and named entity recognition. In one embodiment, the server uses a pre-trained language model library to convert each token in the inquiry text into a vector representation in a multidimensional embedding space. The server applies an intent classifier implemented as a feedforward neural network that receives the sequence of token embeddings or a pooled representation thereof, and outputs a probability distribution over predefined intent classes such as “information request”, “incident report”, “project status request”, “key person request”, or “general inquiry”. The server selects as the intent of the inquiry the class with highest probability exceeding a threshold.

The server uses the same or a different neural network to extract a target event and important expressions. For example, the server applies a sequence labeling model, such as a bidirectional recurrent neural network with an attention layer, which outputs for each token a label indicating whether the token belongs to an entity of type project, facility, product, or system. The server groups tokens with consistent labels to form entity spans and stores these as important expressions, together with entity types and confidence scores, in the integrated data storage. By representing intent, target event, and important expressions as structured data, the server reduces the amount of text that must be re-analyzed downstream and enables efficient indexing and retrieval in the database.

The server estimates an emotion state from the inquiry text. In one embodiment, the server uses an emotion analysis model implemented as a neural network that receives sentence-level embeddings as input and outputs scores for multiple emotion dimensions, such as anger, dissatisfaction, anxiety, and satisfaction. The neural network may be a multilayer perceptron trained using a loss function such as cross-entropy on labeled emotion datasets. The server normalizes the emotion scores and selects one or more emotions whose scores exceed predetermined thresholds, and records the selected emotions as the emotion state of the inquiry. The server stores the emotion state as numeric scores and labels in the inquiry management storage area.

The server determines a type of business function and a processing priority based on the identified intent, target event, important expressions, and emotion state. The server uses a rule set or a learned classifier that maps combinations of intent and target event types to business function types such as “product information function”, “troubleshooting function”, “key person search function”, or “security incident function”. The server calculates a processing priority by combining a base priority for each business function type with a correction factor derived from the emotion scores and from attributes of the target event, such as whether the target event corresponds to a critical system or facility. The server stores the processing priority in the inquiry management storage area and uses the processing priority to schedule subsequent processing tasks and to control queueing at the server.

The server generates a prompt sentence to be input to a generative AI model. The generative AI model is a generative information processing apparatus implemented as a trained neural network that receives a text input and generates text or structured data as output. In one embodiment, the generative AI model has a transformer architecture with multiple self-attention layers, feedforward layers, and positional encoding. The model has been trained on a large corpus of text to predict next tokens and then fine-tuned on domain-specific inquiries and responses. The server constructs the prompt sentence by concatenating templates and dynamic fields. The templates are stored in the integrated data storage and specify, for each business function type and emotion state combination, a response policy and writing style. For example, when the user is angry and the intent corresponds to troubleshooting, the template may include instructions to generate an empathetic and apologetic response; when the user is anxious and the intent corresponds to a security incident, the template may include instructions to generate concise, step-by-step emergency procedures.

The server inserts into the template the user's inquiry text, the determined intent, the identified target event, and key important expressions. The server optionally includes retrieved business records or person records as context. For example, the server may generate a prompt sentence such as:

“The user is angry and reports a system failure. User message: ‘The system is not working!

This is unacceptable!’ You are a technical support assistant. Provide an apologetic and empathetic response, and ask for the minimal technical details needed to start diagnosis.”

In another example, when performing a key person search for a project, the server may generate a prompt sentence such as:

“The user is asking: ‘I want to know about the marketing strategy for the new product.’

Based on the following summary of project and staff data, identify the key person responsible for this topic and describe the person's role.”

The server provides the prompt sentence as sequential tokens to the generative AI model and receives the generated output tokens from the model. The server executes inference using the generative AI model on dedicated computation resources such as GPUs or accelerators, which reduces latency and allows parallel processing of multiple inquiries.

The server uses the generative AI model output in two distinct ways. In one mode, the server requests the generative AI model to generate response information as natural language text.

In another mode, the server instructs the generative AI model, via the prompt sentence, to output structured data in a constrained format, for example as key-value pairs embedded in text. The server then parses the structured part and extracts fields such as candidate target events, suggested contact roles, or recommended actions. By constraining the output format and parsing only the structured parts, the server improves reliability and reduces post-processing complexity.

The server searches the business data storage area and the person data storage area based on important expressions and attribute information included in the structured data. The server uses query generation logic that converts entity labels and roles into database queries. For example, if the structured data contains “facility: Facility A” and “incident_type: alarm”, the server generates a query to a security contact table in the person data storage area filtered by the facility identifier and active flag. The server retrieves one or more person records and selects a person in charge based on role, on-call status, and historical performance metrics. In another example, if the structured data indicates a project name and a role such as “project manager”, the server searches a project assignment table to identify the most relevant person.

The server generates final response text and contact information. The server composes a response object including the response information received from the generative AI model, the retrieved business records, and the selected person-in-charge information. In one embodiment, the server calls the generative AI model again with a second prompt sentence that instructs the model to rewrite or summarize the raw response information and the database content into a coherent message for the user. For example, the second prompt sentence may be:

“Using the following draft answer and contact data, produce a final answer in clear language that includes the key person's name, role, and contact details. Draft answer: ‘The key person is the manager of Project X.’Contact data: name, email, phone.”

By dividing the generative processing into a first stage for semantic extraction and a second stage for final wording, the server isolates the semantic alignment with the internal data structures from stylistic generation, thereby improving both accuracy of database interaction and flexibility of natural language expression.

The server records inquiry data, emotion states, priorities, and response histories in the inquiry management storage area. The server periodically computes statistical information such as distributions of emotion states, average response times per priority level, and success rates of contact identification. The server also collects evaluation information, for example by comparing predicted intents and identified persons in charge with actual outcomes recorded by downstream systems. The server uses these statistical and evaluation results to adjust the generation logic of prompt sentences and weighting parameters in the intent classifier and emotion model. The server may update thresholds for triggering escalation, adjust mapping of emotion intensity to processing priority, and refine templates used to generate prompt sentences. By closing this feedback loop, the server improves the precision of routing, reduces unnecessary load on the generative AI model, and decreases response latency for high-priority inquiries.

In one variation, the server implements the emotion analysis model and the intent classifier as components of a single multi-task neural network sharing lower layers. This multi-task architecture exploits correlations between intents and emotions to improve accuracy for sparse classes, and reduces computational cost by reusing intermediate representations. In another variation, the server uses a separate rule-based module to post-process the outputs of the neural models to enforce domain-specific constraints, such as always assigning maximum priority to security incidents involving certain critical facilities regardless of emotion intensity.

The system produces technical effects on computer operation beyond mere automation of human tasks. Because the server analyzes inquiry text to determine intent, target event, important expressions, and emotion in a unified pipeline, the server can predict which inquiries will likely require heavier downstream computation, such as complex generative responses or multi-table database joins. Based on this prediction, the server can schedule expensive operations, prefetch relevant database records, or select lower-cost model configurations for low-priority inquiries. This adaptive scheduling reduces peak CPU and memory usage, improves throughput, and shortens average response time.

The integration of structured generative AI outputs with internal databases also improves data management. The server reduces duplication of entity extraction logic by centralizing it in the generative AI model and the natural language processing module, and uses structured data as stable keys for indexing into databases. This design reduces redundancy of transformation code and minimizes errors in entity resolution, improving overall accuracy of person-in-charge identification and business record retrieval.

The use of prompt sentences is tailored to the internal system architecture. The server explicitly encodes, in the prompt sentence, information not usually available in raw user text, such as processing priority, selected business function type, and required response style. This encoding allows the generative AI model to leverage internal state of the system, thereby generating responses and structured data that are aligned with the server's scheduling and routing policies. The prompt sentences reflect non-conventional rules, such as emotion-dependent escalation conditions and facility-specific incident handling policies, which are not simply derived from user instructions. As a result, the system implements processing strategies that are not mere computerization of human workflow but depend on machine-internal state and computations.

In another embodiment, the server uses alternative generative AI models. For instance, the server may employ an encoder-decoder neural architecture fine-tuned to output structured representations in a fixed schema instead of free-form text. The server may choose the model type based on business function type, using a compact model for simple FAQ tasks and a larger model for complex incident analysis. This dynamic model selection reduces computational load and network bandwidth when communicating with external inference services.

The server can also be configured to integrate sensor data or system logs as additional input for target event identification. For example, when the inquiry text indicates a possible system failure, the server may query a monitoring system for recent error logs and include summary statistics in the prompt sentence, such as error frequency and affected components. By enriching the prompt sentences with real-time technical data, the generative AI model can produce more accurate diagnoses and recommended actions. This combination of log analysis and language understanding reduces false positives and accelerates root-cause inference.

In a further embodiment, the terminal performs limited pre-processing to reduce communication load. The terminal may tokenize the inquiry text and compress the token sequence before transmission. The server then reconstructs the text based on a shared vocabulary. This technique reduces the amount of data transmitted over the network for long inquiries, contributing to lower communication latency and cost, especially for mobile terminals operating on constrained networks.

The described system may be applied not only to internal corporate inquiries but also to customer-facing support in physical stores or service centers. In such use cases, the terminal may be integrated into a handheld device or a wearable device used by a store representative.

The server's ability to rapidly identify popular products, check inventory, and propose relevant contact persons (such as experts in a particular product category) leads to shorter customer wait times and more consistent support quality. However, these benefits arise from the underlying technical improvements in intent and emotion processing, prompt generation, and database integration, rather than from the business context itself.

In still another embodiment, the server maintains multiple versions of prompt generation logic and selects a version according to real-time performance metrics. For example, the server may test a version that uses more detailed templates and longer prompts against a version that uses compact prompts, and compare error rates and latency. The server may adjust the active version based on evaluation information stored in the inquiry management storage area. This adaptive adjustment further optimizes computational efficiency and response quality.

Through these embodiments and variations, the server, the terminal, and the user cooperate in a system where the server performs specific data structures, algorithms, and model-based computations to achieve improved processing speed, accuracy, and resource utilization. The generative AI model, guided by carefully constructed prompt sentences and integrated with internal structured data, operates as a component in a larger technical architecture that improves operation of the underlying computer system.

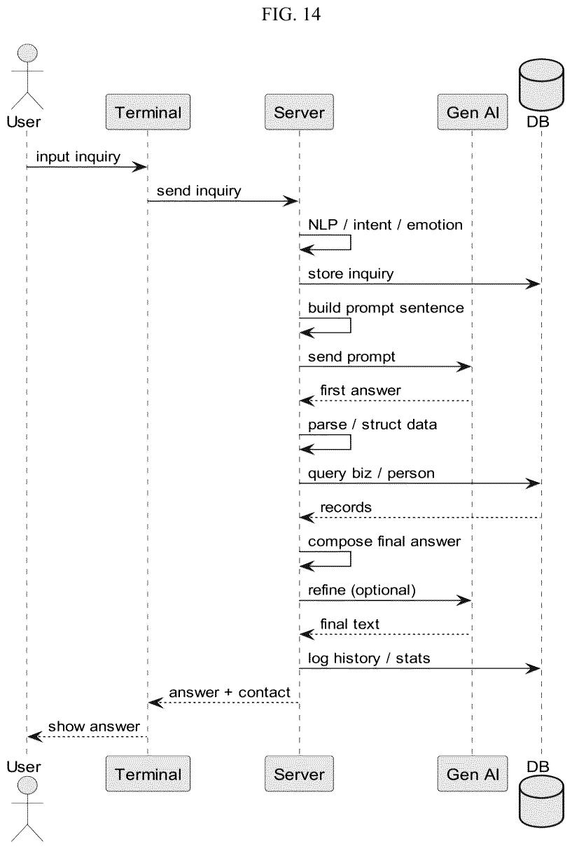

The following describes the processing flow using FIG. 14.

### Step 1

The user operates the terminal to input inquiry text.

The user enters a natural-language question or report, such as “The system is not working! This is unacceptable!” or “I want to know about the new project status,” into a text input field of the terminal. The terminal receives the raw character string as input and temporarily stores the string and metadata (timestamp, terminal identifier, user identifier if available) in local memory. The terminal does not yet modify the semantics of the text; it only converts key events (keystrokes or speech-to-text output) into a continuous text buffer, which becomes the output of this step.

### Step 2

The terminal performs local normalization and packaging of the inquiry.

The terminal takes, as input, the raw inquiry text and associated metadata from Step 1. The terminal removes leading and trailing spaces, normalizes character encoding, and may convert full-width characters to half-width characters or apply lowercasing to alphabetic characters. The terminal then packages the normalized inquiry text and metadata into a structured message object, for example a key-value map with fields such as “inquiry_text,” “user_id,” “terminal_id,” and “timestamp.” The terminal outputs this structured message object as a preparation for network transmission.

### Step 3

The terminal transmits the structured inquiry message to the server.

The terminal takes the structured message object from Step 2 as input. The terminal serializes the object into a network payload, encrypts the payload using a secure transport protocol, and sends the encrypted payload through a network interface to a predefined server endpoint. The terminal uses the metadata to set headers such as content length and content type. The terminal outputs an encrypted network packet stream that reaches the server as the input of the subsequent step.

### Step 4

The server receives and validates the incoming inquiry message.

The server accepts, as input, the encrypted network packet stream transmitted by the terminal in Step 3. The server decrypts the payload using the transport layer security module and deserializes the payload to reconstruct the structured message object. The server verifies authentication tokens, schema validity, and size constraints. If validation succeeds, the server writes a new record into an inquiry data table in the integrated data storage, storing the inquiry text and metadata. The server outputs a normalized internal representation of the inquiry, including an internal inquiry identifier that will be used as a key in later processing.

### Step 5

The server executes natural language preprocessing on the inquiry text.

The server takes, as input, the internal inquiry representation and the inquiry text from Step 4. The server invokes a natural language processing library to tokenize the text into tokens and sentences, perform part-of-speech tagging, and run syntactic parsing. The server additionally computes vector embeddings for tokens or sentences using a pre-trained embedding model.

From these computations, the server outputs a structured analysis object that contains token sequences, linguistic tags, parse trees, and embedding vectors associated with the inquiry identifier.

### Step 6

The server determines the intent, target event, and important expressions.

The server uses, as input, the structured analysis object from Step 5. The server feeds the embedding sequences into an intent classification neural network that computes a probability distribution over intent classes. The server selects the highest-probability intent and stores it.

In parallel, the server applies an entity recognition model to the token sequence to assign an entity type label (such as project, facility, product, or system) to each token. The server groups labeled tokens into entity spans and calculates confidence scores. The server designates spans with confidence above a threshold as important expressions and maps them to a target event when appropriate. The server outputs a semantic profile for the inquiry, including an intent label, a target event identifier (if any), and a list of important expressions with associated types and scores.

### Step 7

The server estimates the user's emotion state and computes a processing priority.

The server takes, as input, the inquiry text and the semantic profile from Step 6. The server feeds a sentence embedding of the inquiry text into an emotion classification network that outputs numeric scores for emotion categories such as anger, dissatisfaction, anxiety, and satisfaction. The server normalizes these scores and selects the dominant emotion or combination of emotions. Then the server uses the intent, the target event, and the emotion scores as input to a priority calculation function, which may be a rule-based function or a learned regression model. The function computes a processing priority level (for example, low, normal, high, or critical). The server stores the emotion state and the priority level in the inquiry management storage area and outputs an augmented semantic profile that now includes intent, target event, important expressions, emotion state, and processing priority.

### Step 8

The server determines a business function type for handling the inquiry.

The server uses, as input, the augmented semantic profile from Step 7. The server applies a mapping module that combines intent and target event type to select a business function type such as “product information function,” “troubleshooting function,” “key person search function,” or “security incident function.” This mapping may use decision rules or a classifier trained on historical labeled data. The server attaches the selected business function type to the inquiry record and outputs a routing decision object indicating which internal functional module should process the inquiry and with which priority.

### Step 9

The server constructs a prompt sentence for a generative AI model.

The server takes the routing decision object, the augmented semantic profile, and the original inquiry text as input. The server selects a prompt template based on the business function type and, optionally, on the emotion state and processing priority. The template specifies placeholders for user message, intent, target event description, and required response characteristics (for example, tone and detail level). The server fills the placeholders with actual data, such as the inquiry text and target event name, and appends instructions that encode the response policy and style. For example, when the user is angry and the function type is troubleshooting, the server may generate:

“The user is very angry about a system failure. User message: ‘The system is not working! This is unacceptable!’ You are a technical support assistant. Write an apologetic and empathetic response and ask for the minimal technical details needed to start diagnosis.”

The server outputs this prompt sentence as a linear sequence of tokens ready for input into the generative AI model.

### Step 10

The server sends the prompt sentence to the generative AI model and obtains a first-stage output.

The server uses, as input, the prompt sentence generated in Step 9. The server converts the tokens to numerical indices using a shared vocabulary and feeds the indices into a neural network implementing a generative AI model, such as a transformer model, either on local accelerators or via an external inference service. The model performs attention and feedforward computations over multiple layers to predict next-token distributions and generate output tokens sequentially until an end condition is met. The server decodes the output tokens back to text. Depending on the template, the model output may contain both narrative text and structured markers indicating entities, actions, or roles. The server outputs this first-stage AI output text as an intermediate response.

### Step 11

The server extracts structured data from the first-stage AI output.

The server takes the first-stage AI output text from Step 10 as input. The server applies either regular expressions, a lightweight parser, or a secondary classifier to detect structured patterns, such as “facility: . . . ”, “incident_type: . . . ”, “role: . . . ”, or “recommended_action: . . . ”. The server converts these patterns into structured fields with keys and values, and associates these fields with the inquiry identifier. The server may cross-check entity names against internal dictionaries to correct spelling and map them to internal identifiers. The server outputs a structured data object containing refined target event values, potential person roles, and suggested actions.

### Step 12

The server queries the integrated data storage using the structured data.

The server uses, as input, the structured data object from Step 11. The server generates database queries based on target event identifiers, roles, and other attributes. For example, if the structured data includes “facility: Facility A” and “role: security_contact,” the server generates a selection query against the person data storage area filtered by facility identifier and role. If the structured data includes a project name and “role: project_manager,” the server queries a project assignment table. The server executes the queries on the database engine and receives matching records. The server may apply ranking rules using fields such as “responsibility_level,” “on_call_flag,” or historical reliability scores. The server outputs selected business records and person-in-charge records linked to the inquiry.

### Step 13

The server composes a combined information set for final response generation.

The server takes, as input, the first-stage AI output text from Step 10 and the selected records from Step 12. The server merges these sources into a unified internal structure that includes: AI-generated explanatory text, database-retrieved factual data, and person-in-charge contact information. The server resolves conflicts between model suggestions and authoritative database entries by giving precedence to database values for identifiers, phone numbers, and email addresses. The result is an enriched context object containing all content needed for the final response. The server outputs this enriched context object.

### Step 14

The server optionally generates a second-stage prompt sentence and refines the response.

The server uses the enriched context object from Step 13 as input. The server creates a second-stage prompt sentence instructing the generative AI model to rephrase, summarize, or structure the combined information for user presentation. The server includes in the prompt the draft text from the first stage and the key fields from the database. For example, the server may generate:

“Using the following draft answer and contact data, produce a final answer in clear language that includes the key person's name, role, and contact details. Draft answer: ‘The key person is the manager of Project X.’ Contact data: name, role, email address, and phone number.”

The server feeds this second-stage prompt sentence into the generative AI model, receives refined output text, and outputs this as the final response text associated with the inquiry.

### Step 15

The server transmits the final response text and contact information to the terminal.

The server takes, as input, the final response text from Step 14 (or directly from Step 13 if no refinement is used) and the selected person-in-charge contact information from Step 12. The server encapsulates these in a response object with fields such as “response_text,” “contact_name,” “contact_role,” “contact_email,” and “contact_phone.” The server serializes the response object, encrypts the payload, and sends the data back to the originating terminal using the established network connection. The server's output is an encrypted response payload containing both narrative answer and structured contact data.

### Step 16

The terminal receives, parses, and displays the response to the user.

The terminal takes the encrypted response payload from Step 15 as input. The terminal decrypts and deserializes the payload to reconstruct the response object. The terminal extracts the response text and contact information fields and selects a user interface layout appropriate to the content, such as a chat bubble with the answer text and clickable elements for email or phone calls. The terminal renders the text on the display and configures the input device so that the user can tap or click on the contact information to initiate external communication.

The terminal outputs a visual and interactive representation of the response for the user.

### Step 17

The server records response history and updates statistical and evaluation information.

The server also takes the final response text and the time of response as input when sending the response in Step 15. The server writes an entry into the inquiry management storage area, including the inquiry identifier, emotion state, processing priority, timestamps, selected business function type, and a summary or identifier of the final response. At predetermined intervals, the server aggregates these records to compute statistical measures such as average response time per priority, accuracy of person-in-charge selection, and distributions of emotion states. The server then updates parameters used in intent, emotion, and priority models and may adjust templates and rules for prompt sentence generation. The server outputs updated model parameters and template configurations, which will influence the processing of subsequent inquiries.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

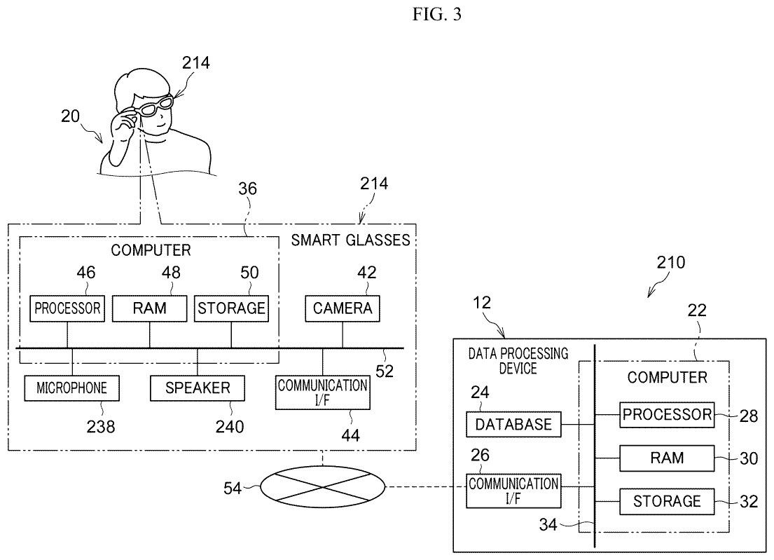

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

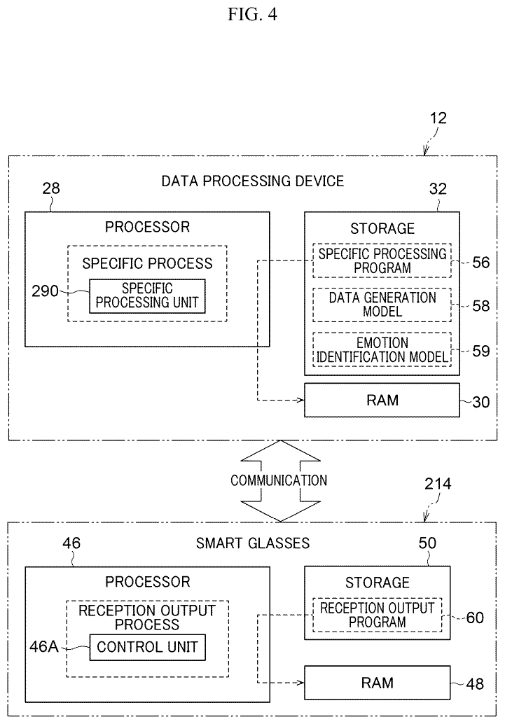

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

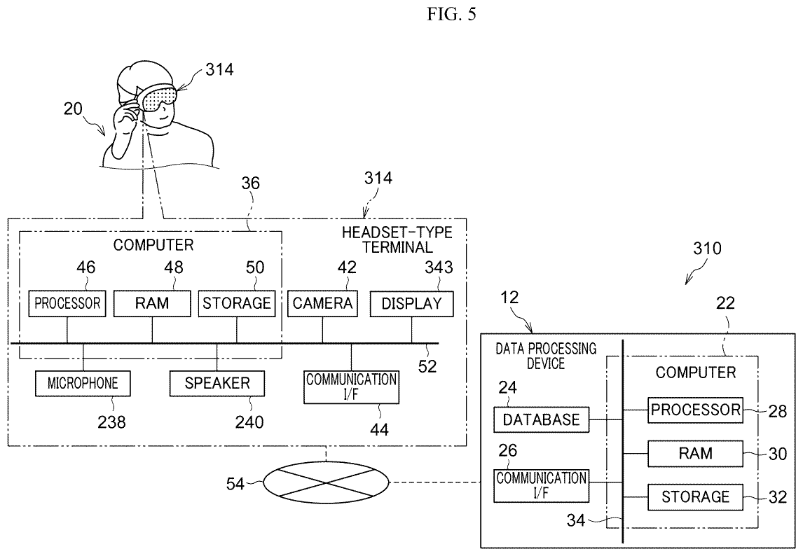

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

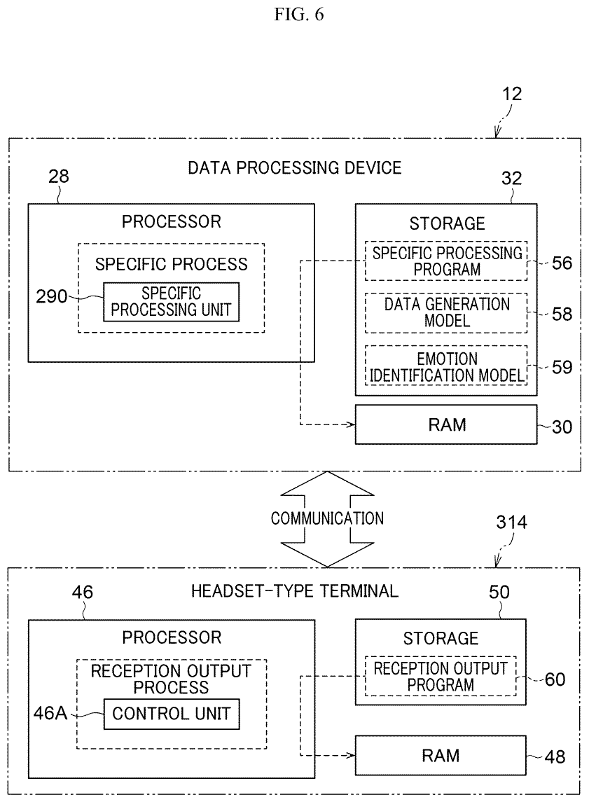

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

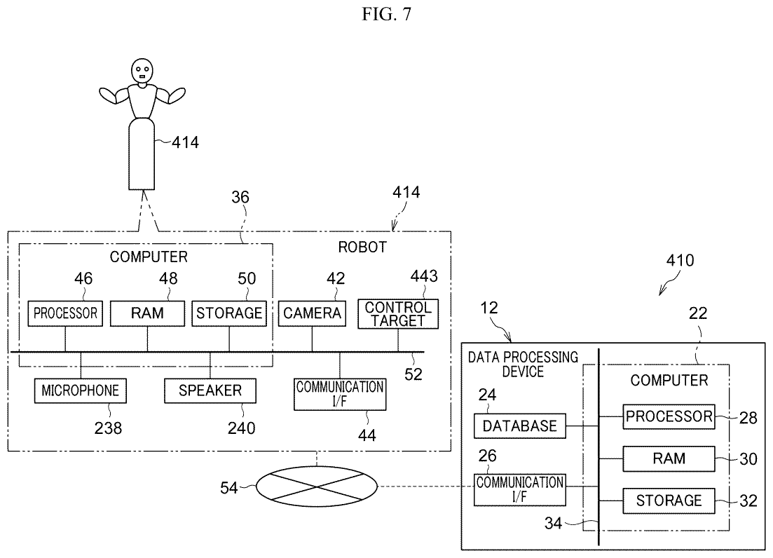

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

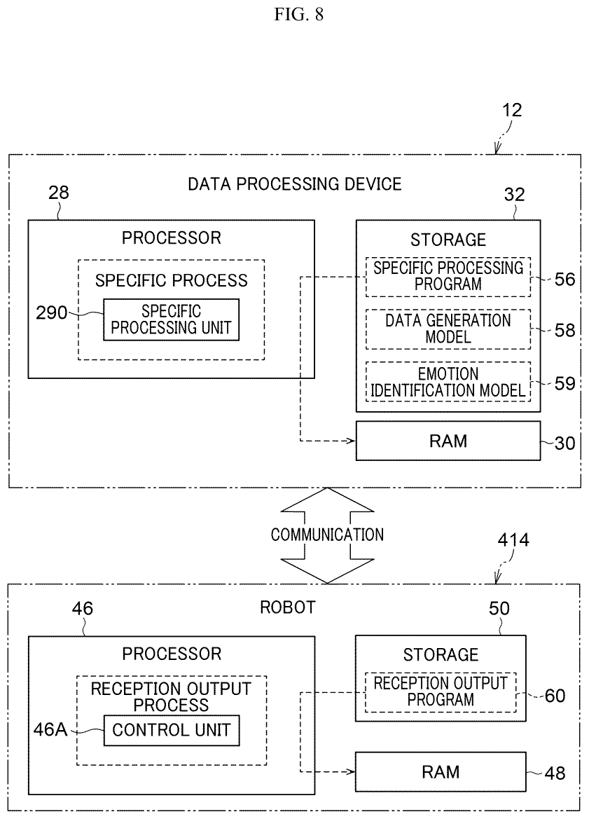

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

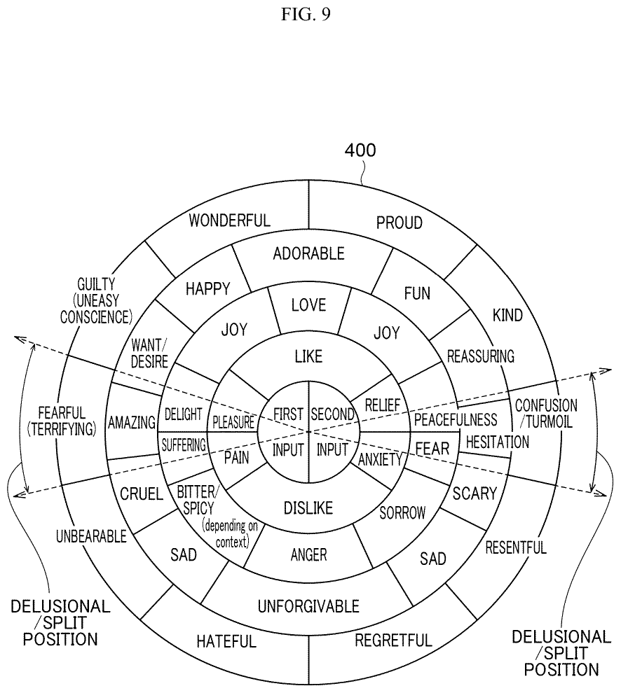

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

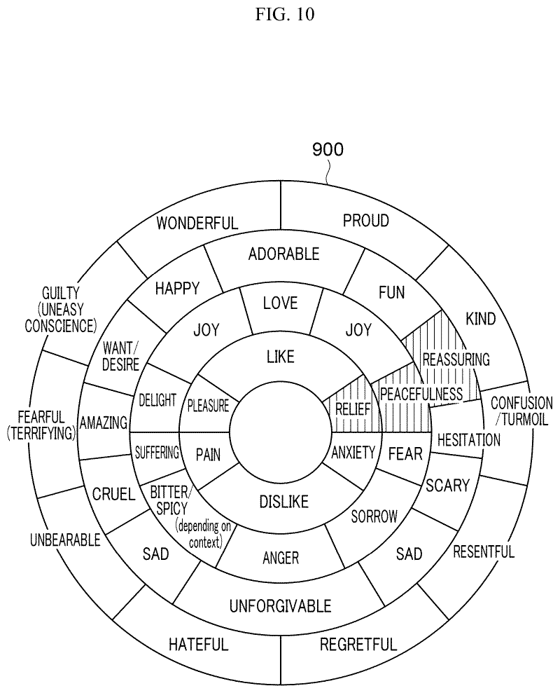

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
centrally receive, via a communication interface, inquiry information acquired from a plurality of inquiry reception units within an organization, and store the inquiry information together with source identification information as inquiry records in a storage unit; and perform string normalization processing and morphological analysis processing on natural language text included in the inquiry records, determine an intent classification and an importance classification of each inquiry, and acquire business-related information from an information processing apparatus or an information management apparatus based on the intent classification and the importance classification; and
construct a prompt sentence including the natural language text included in the inquiry records, the intent classification, the importance classification, and the business-related information, the prompt sentence being configured to cause a generative artificial intelligence model to execute context analysis and answer generation processing, and transmit the prompt sentence to the generative artificial intelligence model via an external interface; and
receive a natural language answer output from the generative artificial intelligence model in response to the prompt sentence, perform output format conversion processing and confidential information control processing on contents of the natural language answer, and output display data to an inquiry terminal; and
store the natural language answer, the corresponding prompt sentence, and the corresponding inquiry record in association with one another as history information, and update at least one of a construction rule of the prompt sentence and an acquisition condition of the business-related information based on the history information.

### Supplementary 2

The system according to supplementary 1,
wherein the processor is configured to, when the intent classification corresponds to at least one of a business-person-in-charge identification and a responsible-person identification, generate a search condition for a person management database including organization structure information and job information, search the person management database based on business attribute information extracted from the natural language text included in the inquiry records, acquire candidate person information, and include the candidate person information in the prompt sentence so as to cause the generative artificial intelligence model to perform important person search and contact information presentation.

### Supplementary 3

The system according to supplementary 1,
wherein the processor is configured to select control parameters including at least one of a model type for the generative artificial intelligence model, an output length control value, and a generation diversity control value, based on a preprocessing result for the inquiry records and the history information, and provide the control parameters to the generative artificial intelligence model together with the prompt sentence via the external interface so as to cause the generative artificial intelligence model to perform answer generation processing according to a category and the importance classification of each inquiry.

### Application Example 1

### Supplementary 1

A system comprising a processor, an input/output device, a storage device, and a communication interface,
wherein the processor is configured to
collect voice data and character data as inquiry data in an integrated manner from a plurality of inquiry terminal devices within an organization via the communication interface, and store the inquiry data in an integrated storage device,
convert, in cooperation with the inquiry terminal device, voice data into character data by using a speech recognition processing function of the inquiry terminal device, generate inquiry data including the character data, user identification information, and work status information, and receive the inquiry data from the inquiry terminal device via a communication network,
analyze the inquiry data by using a natural language processing technique, determine an inquiry type and a required business process, acquire business-related data from an internal information processing device in accordance with the inquiry type and the required business process, and generate a prompt sentence including the inquiry data and the business-related data and instruct a generative AI model to receive the prompt sentence as input,
obtain answer character data generated by the generative AI model based on the prompt sentence, verify contents of the answer character data based on the business-related data, and correct the answer character data so as to match the business-related data when necessary, transmit corrected answer character data to the inquiry terminal device, cause the inquiry terminal device to convert the corrected answer character data into voice data by using a speech synthesis processing function, and cause the inquiry terminal device to present the voice data to a user via an output device, and
store the inquiry data and the answer character data generated by the generative AI model, in association with each other, in the integrated storage device as inquiry records, and make the inquiry records available for subsequent prompt sentence generation processing based on inquiry history.

### Supplementary 2

The system according to supplementary 1,
wherein the processor is configured to
classify the inquiry data by using a natural language processing technique, generate, according to an inquiry type, a prompt sentence to which business-related data acquired from a business management device or a business recording device is added, instruct the generative AI model to perform context analysis and answer generation with respect to the prompt sentence, and provide, to the inquiry terminal device, answer character data output from the generative AI model as both structured information and natural language text.

### Supplementary 3

The system according to supplementary 1,
wherein the processor is configured to
analyze contents of the inquiry data, search a person-related storage device based on a business field, equipment information, work classification, and time information that are included in or derived from the inquiry data, generate person-related data including responsible person information obtained as a search result, generate a prompt sentence into which the person-related data is incorporated, instruct the generative AI model to receive the prompt sentence as input, and cause the inquiry terminal device to receive answer character data generated by the generative AI model based on the prompt sentence, the answer character data including the responsible person information and contact information.

### Example 2

### Supplementary 1

A system comprising a processor,
wherein the processor is configured to
collect inquiry data from a plurality of inquiry channels within an organization and store the inquiry data in an integrated storage,
acquire, as the inquiry data, inquiry text in natural language received from an information terminal operated by a user, and execute natural language processing including morphological analysis, syntactic analysis, and semantic analysis on the inquiry text to extract keywords, intent, category, and context information,
search, based on the extracted keywords, intent, category, and context information, for related information from a knowledge base using a structured query language or similarity search, and generate a prompt sentence for input to a generative AI model by combining the related information with the inquiry text,
input the generated prompt sentence to the generative AI model executed by a deep learning framework, and cause the generative AI model to perform text generation processing to infer an answer sentence in natural language,
analyze the generated answer sentence, format the answer sentence into structured data corresponding to a sequence of steps, a list, or a business process flow, and apply a result of the formatting to a business process management function or a business support function, and
generate output data by which the formatted answer sentence is transmitted to the information terminal of the user and presented to the user.

### Supplementary 2

The system according to supplementary 1,
wherein the processor is configured to
generate the prompt sentence by selecting a template associated with the extracted keywords and the category, and embedding the inquiry text and the searched related information into the template so as to dynamically generate the prompt sentence that instructs the generative AI model to perform context analysis and answer generation.

### Supplementary 3

The system according to supplementary 1,
wherein the processor is configured to
execute the natural language processing by integrally analyzing the inquiry text together with past inquiry history and past answer history, and include an analysis result in the prompt sentence so that the generative AI model generates the answer sentence in consideration of context based on a dialogue history.

### Application Example 2

### Supplementary 1

A system comprising a processor,
wherein the processor is configured to
collect inquiry data in an integrated manner from a plurality of inquiry windows within an organization and store the inquiry data in an integrated data storage, analyze inquiry text acquired from a user terminal by using natural language processing technology, and identify, based on an analysis result, an intent of the inquiry, a target event, important expressions, and an emotion state,
determine, in accordance with the identified intent, the target event, the important expressions, and the emotion state, a type of business function for processing the inquiry and a processing priority, and dynamically generate a prompt sentence to be input to a generative information processing apparatus,
input the prompt sentence to the generative information processing apparatus and acquire response information or structured data generated by the generative information processing apparatus,
search, based on the important expressions and attribute information included in the acquired structured data, a business data storage area and a person data storage area in the integrated data storage, and extract business information and person-in-charge information related to a content of the inquiry,
generate, based on the response information acquired from the generative information processing apparatus and the extracted business information and person-in-charge information, final response text and contact information, and transmit the final response text and the contact information to the user terminal, and
record, based on the emotion state and the processing priority, the inquiry data and response history in an inquiry management storage area, generate statistical information or evaluation information, and update a generation logic of the prompt sentence.

### Supplementary 2

The system according to supplementary 1,
wherein the processor is configured to
determine, based on the emotion state identified from the inquiry text, at least one of a processing priority of the inquiry and a necessity of escalation, and generate the prompt sentence so as to include a response policy and a writing style corresponding to the processing priority or the necessity of escalation, and instruct the generative information processing apparatus to generate response text corresponding to the emotion state.

### Supplementary 3

The system according to supplementary 1,
wherein the processor is configured to
generate, based on the inquiry text and the emotion state, search conditions as the prompt sentence for identifying a person in charge having a highest relevance to a content of the inquiry, use a target event and role information included in the structured data output from the generative information processing apparatus to search the person data storage area, and provide contact information of the identified person in charge to the user terminal together with the final response text.

What is claimed is:

1. A system comprising:
circuitry configured to:
receive, via a communication interface coupled to a packet-switched network, input data records from a plurality of reception interfaces, and store the input data records together with source identification data in a storage device;
apply string normalization processing and morphological analysis processing to natural language text included in each input data record to determine an intent classification and an importance classification;
retrieve, based on the intent classification and the importance classification, context data from at least one information management apparatus coupled to the communication interface;
construct a prompt data structure comprising the natural language text, the intent classification, the importance classification, and the context data, and transmit the prompt data structure together with control parameters to a generative neural network model;
receive, from the generative neural network model, a natural language response generated based on the prompt data structure, and perform output format conversion processing and restricted-information control processing on the natural language response to generate display data for transmission to a terminal device; and
store, in the storage device, the natural language response, the prompt data structure, and the corresponding input data record in association with one another as history data, and update at least one of a construction rule of the prompt data structure and an acquisition condition of the context data based on the history data.

2. The system according to claim 1,
wherein the control parameters comprise at least one of a model type identifier for the generative neural network model, an output length control value, and a generation diversity control value, the control parameters being selected based on the intent classification and the importance classification of the input data record.

3. The system according to claim 2,
wherein the circuitry is further configured to, when the intent classification corresponds to a person identification request, generate a search condition for a person data storage comprising role data and organizational attribute data, search the person data storage based on attribute data extracted from the natural language text, acquire candidate person data, and include the candidate person data in the prompt data structure to cause the generative neural network model to generate contact information associated with the candidate person data.

4. The system according to claim 3,
wherein the circuitry generates the search condition by combining extracted attribute data with a target event identifier and role classification data derived from the natural language text, and ranks candidate person data by a relevance score computed from a match between the extracted attribute data and the role data in the person data storage.

5. The system according to claim 1,
wherein the circuitry is further configured to receive, from a plurality of terminal devices, both voice data and character data as unified input data, cooperate with the terminal devices to convert the voice data into character data using a speech recognition function, and generate structured input data comprising the character data, user identification data, and operational status data.

6. The system according to claim 5,
wherein the circuitry is further configured to obtain response character data from the generative neural network model, verify contents of the response character data against the context data retrieved from the information management apparatus, correct the response character data to resolve inconsistencies with the context data, and transmit corrected response character data to the terminal device for conversion into voice data using a speech synthesis function.

7. The system according to claim 6,
wherein verifying the contents comprises comparing entity references and numerical values in the response character data against corresponding fields in the context data, and the correcting comprises replacing inconsistent entity references or numerical values with verified values from the context data while preserving sentence structure of the response character data.

8. The system according to claim 1,
wherein the circuitry is further configured to execute natural language processing comprising morphological analysis, syntactic analysis, and semantic analysis on the natural language text to extract keywords, intent data, category data, and context information, and search a knowledge base stored in the storage device using at least one of a structured query and a similarity search based on the extracted keywords and category data to retrieve related information for inclusion in the prompt data structure.

9. The system according to claim 8,
wherein the circuitry constructs the prompt data structure by selecting a template associated with the extracted keywords and the category data, and embedding the natural language text and the related information into the selected template to dynamically generate the prompt data structure.

10. The system according to claim 9,
wherein the circuitry is further configured to execute the natural language processing by jointly analyzing the natural language text together with past input data records and past response data retrieved from the history data, and include a joint analysis result in the prompt data structure so that the generative neural network model generates the natural language response in consideration of dialogue history context.

11. The system according to claim 8,
wherein the circuitry is further configured to analyze the natural language response received from the generative neural network model, format the natural language response into structured output data corresponding to at least one of a sequence of procedural steps, a categorized list, and a process flow representation, and apply the structured output data to a process management function accessible via the communication interface.

12. The system according to claim 1,
wherein the circuitry is further configured to identify, from the natural language text, an emotion state of a user by applying a classification model, determine a processing priority based on the emotion state and the importance classification, and generate the prompt data structure to include a response policy and a writing style directive corresponding to the processing priority.

13. The system according to claim 12,
wherein the circuitry is further configured to search, based on extracted attribute data and role information included in structured data output from the generative neural network model, a person data storage to identify a responsible person record having highest relevance to the input data record, and transmit contact data from the responsible person record to the terminal device together with the display data.

14. The system according to claim 13,
wherein the circuitry is further configured to record the input data record and response history in the storage device indexed by the emotion state and the processing priority, generate statistical data or evaluation data from the recorded history, and update a generation logic of the prompt data structure based on the statistical data.

15. The system according to claim 1,
wherein the restricted-information control processing comprises detecting, in the natural language response, data segments matching a restricted-information pattern stored in the storage device, and replacing or redacting the detected data segments prior to generating the display data.

16. The system according to claim 1,
wherein updating the construction rule comprises analyzing the history data to identify correlations between prompt data structure variations and response quality metrics, and modifying template selection criteria or context data retrieval conditions to increase a proportion of high-quality responses in subsequent prompt data structure construction.

17. The system according to claim 16,
wherein the response quality metrics comprise at least one of a user satisfaction indicator received from the terminal device, a factual consistency score computed by comparing the natural language response against the context data, and a response latency measurement.

18. A system comprising:
circuitry configured to:
receive input data records from a plurality of reception interfaces via a communication interface coupled to a packet-switched network, and store the input data records with source identification data in a storage device;
apply normalization and morphological analysis to natural language text in each input data record to determine an intent classification and an importance classification;
retrieve context data from an information management apparatus based on the intent classification and the importance classification;
construct a prompt data structure comprising the natural language text, the intent classification, the importance classification, and the context data, select control parameters based on the intent classification and the importance classification, and transmit the prompt data structure with the control parameters to a generative neural network model;
receive a natural language response, perform output format conversion and restricted-information control processing, and generate display data for a terminal device;
store the natural language response, the prompt data structure, and the input data record in association as history data; and
analyze the history data to update at least one of a prompt construction rule and a context data acquisition condition based on response quality metrics derived from the history data.

19. The system according to claim 18,
wherein the circuitry is further configured to identify an emotion state from the natural language text, determine a processing priority based on the emotion state, and include a response policy directive in the prompt data structure corresponding to the processing priority.

20. A method comprising:
receiving, by circuitry via a communication interface coupled to a packet-switched network, input data records from a plurality of reception interfaces, and storing the input data records with source identification data in a storage device;
applying string normalization processing and morphological analysis processing to natural language text in each input data record to determine an intent classification and an importance classification;
retrieving context data from at least one information management apparatus based on the intent classification and the importance classification;
constructing a prompt data structure comprising the natural language text, the intent classification, the importance classification, and the context data, and transmitting the prompt data structure with control parameters to a generative neural network model;
receiving a natural language response from the generative neural network model, performing output format conversion processing and restricted-information control processing, and generating display data for a terminal device; and
storing the natural language response, the prompt data structure, and the corresponding input data record in association as history data, and updating at least one of a construction rule of the prompt data structure and an acquisition condition of the context data based on the history data.
